(19) United States
(12) Patent Application Publication
(10) Pub. No.: US 2006/0227076 A1
(43) Pub. Date: Oct. 12, 2006

(54) Plasma display apparatus and driving method thereof

(76) Inventor: Nam Jin Kim, Seoul (KR)

Correspondence Address: MCKENNA LONG & ALDRIDGE LLP;Song K. Jung, 1900 K Street, N.W., Washington, DC, 20006, US

(21) Appl. No.: 11/328,180

(22) Filed: Jan. 10, 2006

(30) Foreign Application Priority Data
Apr. 7, 2005 (KR) 10-2005-029188

(51) Int. Cl. G09G 3/28

(52) U.S. Cl. 345/63

(57) ABSTRACT

Disclosed are a plasma display panel, a plasma display apparatus and a driving apparatus and method of the plasma display panel. The plasma display apparatus comprises a plasma display panel comprising a scan electrode and a sustain electrode and a reset pulse controller for controlling a amplitude of reset pulse applied to the scan electrode in the reset period of at least one subfield according to a gray level.

This Nonprovisional application claims priority under 35 U.S.C. §119(a) on Patent Application No. 10-2005-0029188 filed in Korea on Apr. 7, 2005 the entire contents of which are hereby incorporated by reference.

### BACKGROUND OF THE INVENTION

1. Field of the Invention

The present invention relates to a plasma display apparatus, and more particularly, to a plasma display panel, which adjusts the amplitude and the number of reset pulses applied in a reset period in a PAL driving method, a plasma display apparatus and a driving apparatus and method of driving the plasma display panel.

2. Background of the Related Art

Generally, in a plasma display apparatus a barrier rib formed between front and back panels forms each of the unit cells, each cell being filled by an inert gas containing a main discharge gas, such as neon(Ne), helium(He) or a mixed gas of neon and helium(Ne+He), and a small amount of xenon. When discharged by a high frequency voltage, the inert gas generates vacuum ultraviolet rays, and makes phosphor formed between barrier ribs luminescent, thereby creating an image. Such a plasma display panels is considered as one of the next generation display devises due to its thin and lightweight construction.

FIG. 1 shows a structure of a conventional plasma display panel.

As shown in FIG. 1, the plasma display panel comprises a front panel 100 having a plurality of scan electrodes 102 and sustain electrodes 103 arranged in pairs on a front glass 101, which is a display surface for displaying an image, and a rear panel 110 having a plurality of address electrodes 113 arranged on a rear glass 111, which is the back surface thereof, so as to intersect the plural pairs of scan electrodes and sustain electrodes, the front panel 100 and the rear panel 110 being coupled parallel to each other with a predetermined distance there between.

The front panel 100 comprises pairs of scan electrodes 102 and sustain electrodes 103 being adapted to cause mutual discharge in a discharge cell and maintain the luminescence of cells, the scan electrodes 102 and sustain electrodes 103 each being comprised of a transparent electrode a of ITO(Indium Thin Oxide) and a bus electrode b made of metal. The scan electrodes 102 and the sustain electrodes 103 are covered with at least one dielectric layer 104 that limits the discharge current of the scan electrode and the sustain electrode and insulates each of the electrodes. A protective layer 105 with magnesium oxide (MgO) deposited thereto is formed on the front surface of the dielectric layer 104 to enable the discharges easier.

Barrier ribs 112 of a stripe type (or well type) are arranged in parallel on the rear panel 110 to form a plurality of discharge spaces, i.e., discharge cells. A plurality of address electrodes 113 generating vacuum ultraviolet rays by performing address discharges are arranged parallel to the barrier ribs 112. RGB Phosphor 114 for emitting visible rays to display images during an address discharge is coated on the upper side of the rear panel 110. A dielectric layer 115 for protecting the address electrodes 113 is formed between the address electrodes 113 and the phosphor 114.

A method of expressing gray levels in such a plasma display panel will be shown in FIG. 2.

FIG. 2 shows a method of expressing gray levels in a prior art plasma display panel.

As shown in FIG. 2, the method of expressing gray levels of a prior art plasma display panel, one frame is divided into several subfields, having different numbers of emissions. Each of the subfields is divided into a reset period (RPD) for uniformly initializing all cells, an address period (APD) for selecting a discharge cell and a sustain period (SPD) for implementing the gray level depending on the number of discharging. For example, to display a picture using 256 gray levels, a frame period (16.67 ms) corresponding to 1/60 second is divided into eight subfields SF1 to SF8 as shown in FIG. 2. Each of the eight subfields is divided into a reset period, an address period and a sustain period.

The reset period and the address period of each of the subfields are the same every subfield. An address discharge for selecting the discharge cell is generated by a voltage difference between the address electrode and the transparent electrode serving as the scan electrode. The sustain period increases in the ratio of 2ⁿ (n=0, 1, 2, 3, 4, 5, 6, 7) in each of the subfields in proportion to the number of a sustain pulse. Since the sustain period is different in each of the subfields, it is possible to implement the gray level of an image by adjusting the sustain period of each of the subfields, that is, the number of sustain discharges.

FIG. 3 shows a driving waveform according to the driving method of a prior art plasma display panel.

As shown in FIG. 3, the PDP is driven with it being divided into a reset period for initializing all cells, an address period for selecting a discharge cell, a sustain period for maintaining the discharges of a selected cell, and an erasing period for erasing wall charges within discharge cells.

In the reset period, a rising ramp waveform Ramp-up is simultaneously applied to all the scan electrodes Y in a set-up period. A weak dark discharge is generated within the cells at the full field with the aid of the rising ramp waveform Ramp-up. By this set-up discharge, positive wall charges are accumulated onto the address electrode and the sustain electrode while negative wall charges are accumulated onto the scan electrode.

In a set-down period SD, a falling ramp waveform Ramp-down falling from a positive voltage lower than a peak voltage of the rising ramp waveform Ramp-up to a ground voltage GND or given voltage level of the negative polarity is simultaneously applied to the scan electrodes Y after the rising ramp waveform Ramp-up was applied. The falling ramp waveform Ramp-down causes a weak erasure discharge within the cells to erase a portion of excessively formed wall charges. Wall charges enough to generate a stable address discharge are uniformly left within the cells with the aid of the set-down discharge.

In the address period, a negative scanning pulse is sequentially applied to the scan electrodes and, at the same time, a positive data pulse is applied to the address electrodes in synchronization with the scanning pulse. A voltage difference between the scanning pulse and the data pulse is added to a wall voltage generated in the reset period to thereby generate an address discharge within the cells supplied with the data pulse. Wall charges enough to cause a discharge when a sustain voltage Vs is applied are formed within the cells selected by the address discharge. Positive voltage Vz is supplied to the sustain electrode for the set-down period and the address period prevent to generate a mis-discharge between the scan electrode and the sustain electrode by reducing the voltage difference there between.

In the sustain period, sustain pulses Sus are alternately applied to the scan electrodes and the sustain electrodes. In the cells selected by the address discharge, a sustain discharge, i.e., display discharge, is generated between the scan electrode and the sustain electrode whenever each sustain pulse is applied as the wall voltage within the cell is added to the sustain pulse.

Just, after the sustain discharge finishes, in an erasing period, an erasing ramp waveform Ramp-ers having a small pulse width and a low voltage level is applied to the sustain electrode thereby erasing wall charges left within the cells of the entire subfield.

In the prior art driving waveform thus described, the amplitude of reset pulse is the same in every subfield.

The amplitude of reset pulse in the prior art driving waveform will be shown in FIG. 4.

FIG. 4 explains a reset pulse in more detail in the driving waveform according to the driving method of the prior art plasma display panel of FIG. 3.

As shown in FIG. 4, in the driving waveform according to the driving method of a prior art plasma display panel, the amplitude of reset pulse is the same in every subfield.

For example, in a reset pulse applied to the scan electrodes in the reset period of each subfield in the prior art driving waveform as shown in FIG. 4, a rising ramp rising with a given slope from a given positive voltage, for instance, a sustain voltage Vs, to a set-up voltage Vsetup and then falls to a given positive voltage.

In the above-described prior art driving method in which reset pulses of the same amplitude are applied to each subfield, since the amplitude of reset pulses is the same in every subfield, the weight value is relatively low. i.e., the gray level value is relatively low. Thus, in low gray level subfields for implementing low gray levels, a sufficient amount of wall charges cannot be generated within discharge cells in the reset period when compared with other high gray level subfields. As a consequence, in low gray level subfields having a relatively low gray level value, a subsequent address discharge becomes unstable, and a sustain discharge after the address discharge becomes unstable too.

In high gray level subfields having a relatively high gray level value, since discharge cells of the plasma display panel can be sufficiently initialized in the reset period, the driving margin is relatively high. However, such driving waveform generates a relatively strong discharge due to a relatively high set-up voltage Vsetup in the reset period of each subfield.

As a consequence, the amount of unnecessary discharge not contributing to an image display increases and cause contrast to deteriorate.

Unlike the above example, in the prior art, it was desired to improve the contrast not by applying a reset pulse in the reset period of each subfield of one frame as described above, but by applying a reset pulse to only one or more subfields selected within one frame. For example, an image is implemented by including subfields of both the selective writing mode and the selective erasing mode in one frame.

A driving method using both the selective writing subfields and the selective erasing subfields will be shown in FIG. 5.

FIG. 5 comprises explains a driving method in which both selective writing subfields and selective erasing subfields are comprised in one frame.

As shown in FIG. 5, one frame comprises selective writing subfield WSF having more than one subfield and selective erasing subfield ESF having more than one subfield.

The selective writing subfield WSF comprises m (m is a positive integer) subfields (SF1, . . . , SFm). The first through the m−1th subfields (SF1 to SFm−1) except the mth subfield (SFm) each is divided into a reset period forming a constant quantity of wall electrical charge uniformly on the cell of the total screen, a selective writing address period (hereinafter, referred to as “writing address period”,) selecting on-cells by writing discharge, a sustain period causing sustain discharge of selected on-cells and an erasing period erasing the wall electrical charge after the sustain period and the sustain discharge.

The mth subfield, which is the last subfield of the selective writing subfield WSF, is divided into a reset period, a writing address period and a sustain period. The reset period, writing address period and erasing period of the selective writing subfield WSF are set up equally on the subfields (SF1, . . . , SFm) of the selective erasing subfield (ESF) and the sustain period is set up equally or differently according to a preset weight value of brightness.

The selective erasing subfield ESF comprises n-m (n is a positive integer and greater than m) subfields (SFm+1, . . . , SFn). Each m+1 through n subfields (SFm+1, . . . , SFn) is divided into a selective erasing address period(hereinafter, referred to as “erasing address period ”) selecting off-cells by erasing discharge and a sustain period causing sustain discharge on on-cells. The erasing address period is set up equally on the subfields (SFm+1, . . . , SFn) of the selective erasing subfield (ESF) and the sustain period is set up equally or differently according to relative ratio of brightness.

In the driving method of FIG. 3, by driving m subfields as selective writing mode and n-m subfields as selective erasing mode, the address period can be shortened. In other words, enough sustain period can be ensured by one frame's including a selective erasing subfield having a short scan pulse.

A reset pulse in each of the subfields in the driving method in which both selective writing subfields and selective erasing subfields are comprised as shown in FIG. 5 will be described in more detail in FIG. 6.

FIG. 6 explains the amplitude of reset pulse applied to the scan electrodes in the reset period in the driving method of FIG. 5.

As shown in FIG. 6, in the driving method in which both selective writing subfields and selective erasing subfields are comprised as shown in FIG. 5, a reset period is comprised only in the selective writing subfields and a reset pulse is applied.

For example, if the first subfield is a selective writing subfield, and the other subfields, i.e., the second to n-th subfields, are selective erasing subfields, a reset pulse is applied only to the first subfield, which is a selective writing subfield, and no reset pulse is applied to the other subfields. As a consequence, the amount of unnecessary discharge not contributing to an image display decreases, thereby improving the contrast in comparison with FIG. 4.

However, in this driving method, a driving margin decreases because it is difficult to sufficiently initialize the discharge cells of the plasma display panel as compared to the prior art driving method in which reset pulse is applied in the reset period of each subfield.

In the plasma display panel driven by the aforementioned driving method, generally, flicker occurs.

Such flicker occurs when the decay time of the phosphor is shorter than the vertical frequency (frame frequency) of an image signal. For example, if the vertical frequency is 60 Hz, one frame image is displayed per 16.67 m/sec. The reaction velocity of the phosphor becomes faster than the vertical frequency, thereby causing flicker of the screen.

In particular, in the PAL (phase alternating line) method, the vertical frequency is 50 Hz, which is relatively short, thereby making the occurrence of flicker more problematic.

In the PAL method, the arrangement of the subfields within one frame is made in a plurality of stages, to reduce the above described flicker problem.

The arrangement of subfields in the PAL method will be shown in FIG. 7.

FIG. 7 shows the arrangement of subfields for implementing an image of a plasma display panel in the prior art PAL method.

Referring to FIG. 7, in the prior art PAL method, subfields having different weight values within one frame are arranged in a plurality of groups, preferably, two groups. For example, the first subfield group comprises a subfield with a weight, i.e., gray level of 1, a subfield with a weight of 8, a subfield with a weight of 16, a subfield with a weight of 32 and a subfield with a weight of 64.

The second subfield group comprises a subfield with a weight of 2, a subfield of a weight of 4, a subfield with a weight of 8, a subfield with a weight of 16, a subfield with a weight of 32 and a subfield with a weight of 64.

The sum of weights of the arranged subfields within one frame, i.e., the sum of gray level values, equals to 1+2+4+8+(8+8)+(16+16)+(32+32)+(64+64), that is, 255. As a result, 256 gray levels can be displayed.

In the PAL method in which the plasma display panel is driven by the arrangement of subfields within one frame in two stages, although the occurrence of flicker decreases, the number of subfields having a relatively low weight value, i.e., a low gray level value within one frame increases.

That is, in a conventional method in which the arrangement of subfields within one frame is made in one stage, as shown in FIG. 2, subfields having a relatively low weight value, i.e., a low gray level value, are classified into the first, second, third and fourth subfields having gray level values 1, 2, 4 and 8, respectively, while in the PAL method in which the arrangement of subfields within one frame is made in two stages, subfields having a relatively low weight value, i.e., a relatively low gray level, are the first and second subfields in the first subfield group, and are also the first, second, third and fourth subfields in the second subfield group.

As a consequence, in the PAL method, the number of subfields having a relatively low weight value, i.e., a low gray level value increases as compared to the conventional non-PAL method in which the arrangement of subfields within one frame is made in one stage. Thus, wall charges are not distributed sufficiently within the discharge cells after the address discharge in the initial subfields having a high probability of making the address discharge unstable, i.e., the subfields having a relatively low gray level value, thereby making a subsequent sustain discharge unstable or making the non-occurrence of a sustain discharge more serious.

In the PAL method, the number of subfields comprised in one frame increases. For example, the driving method of FIG. 2 and the driving method of FIG. 7 implement 128 gray levels. In the conventional driving method of FIG. 2, a total of 8 subfields are comprised in one frame, and in the driving method of PAL of FIG. 7, a total of 12 subfields are comprised. Therefore, in the PAL driving method of FIG. 7, the number of set-up pulses is more than the number of set up pulses in the driving method of FIG. 2. As a result, the intensity of unnecessary light generated by set-up pulses within one frame is greater in the driving method of FIG. 8 than in the driving method of FIG. 2. In other words, in the PAL method as shown in FIG. 7, the amount of unnecessary discharge not contributing to an image display is further increased to deteriorate the contrast.

### SUMMARY OF THE INVENTION

Accordingly, an object of the present invention is to solve at least the problems and disadvantages of the background art.

The object of the present invention is to provide a plasma display panel, which improves the contrast by adjusting the amplitude of and number of reset pulses, a plasma display panel and a driving apparatus and method of the plasma display panel.

The plasma display apparatus of the present invention comprises: a plasma display panel comprising a scan electrode and a sustain electrode; and a reset pulse controller for controlling a amplitude of reset pulse applied to the scan electrode in the reset period of at least one subfield according to a gray level.

In the present invention, flicker can be reduced by making a gray level weight value of subfields in the PAL driving method.

In the present invention, the contrast is improved by adjusting the amplitude and number of reset pulses applied to the scan electrode in the reset period.

### BRIEF DESCRIPTION OF THE DRAWINGS

The invention will be described in detail with reference to the following drawings in which like numerals refer to like elements:

FIG. 1 shows a structure of a conventional plasma display panel;

FIG. 2 shows a method of expressing gray levels of a prior art plasma display panel;

FIG. 3 shows a driving waveform according to the driving method of a prior art plasma display panel;

FIG. 4 explains a reset pulse in more detail in the driving waveform according to the driving method of the prior art plasma display panel of FIG. 3;

FIG. 5 explains a driving method in which both selective writing subfields and selective erasing subfields are comprised in one frame;

FIG. 6 explains the amplitude of reset pulse applied to the scan electrodes in the reset period in the driving method of FIG. 5;

FIG. 7 explains the arrangement of subfields for implementing an image of a plasma display panel in the prior art PAL method;

FIG. 8 explains a plasma display apparatus according to the present invention;

FIGS. 9a and 9b explain one example of dividing one frame into a plurality of subfield groups;

FIGS. 10a and 10b explain a first embodiment of a driving method of a plasma display panel according to the present invention;

FIG. 11 explains one example of a low gray level subfield setting method in the first embodiment of the driving method of the plasma display panel according to the present invention;

FIG. 12 explains another driving waveform according to the first embodiment of the driving method of the plasma display panel according to the present invention;

FIG. 13 explains an arrangement of subfields within one subfield group in the first embodiment of the driving method of the plasma display panel according to the present invention;

FIGS. 14a and 14b explain another example of dividing one frame into a plurality of subfield groups;

FIGS. 15a and 15b explain one example of a driving waveform in the driving method having the arrangement order of FIGS. 14a and 14b;

FIGS. 16a and 16b explain another example of dividing one frame into a plurality of subfield groups;

FIGS. 17a and 17b explain another example of dividing one frame into a plurality of subfield groups;

FIGS. 18a and 18b explain a second embodiment of a driving method of a plasma display panel according to the present invention;

FIG. 19 explain one example of a high gray level subfield setting method in the second embodiment of the driving method of the plasma display panel according to the present invention;

FIG. 20 explains another driving waveform according to the second embodiment of the driving method of the plasma display panel according to the present invention;

FIG. 21 explains an arrangement of subfields within one subfield group in the second embodiment of the driving method of the plasma display panel according to the present invention;

FIG. 22 explains another arrangement of subfields within one subfield group in the second embodiment of the driving method of the plasma display panel according to the present invention;

FIG. 23 explains a third embodiment of a driving method of a plasma display panel according to the present invention;

FIG. 24 explains another driving waveform according to the third embodiment of the driving method of the plasma display panel according to the present invention;

FIG. 25 explains one example of a low gray level subfield setting method in the third embodiment of the driving method of the plasma display panel according to the present invention;

FIG. 26 explains one example of a high gray level subfield setting method in the third embodiment of the driving method of the plasma display panel according to the present invention;

FIG. 27 explains an arrangement of subfields within one frame in the third embodiment of the driving method of the plasma display panel according to the present invention;

FIG. 28 explains another arrangement of subfields within one subfield group in the third embodiment of the driving method of the plasma display panel according to the present invention;

FIG. 29 explains a fourth embodiment of a driving method of a plasma display panel according to the present invention;

FIG. 30 explains one example of a low gray level subfield setting method in the fourth embodiment of the driving method of the plasma display panel according to the present invention;

FIG. 31 explains an arrangement of subfields within one frame in the fourth embodiment of the driving method of the plasma display panel according to the present invention; and

FIG. 32 explains the number of reset pulses in the fourth embodiment of the driving method of the plasma display panel according to the present invention.

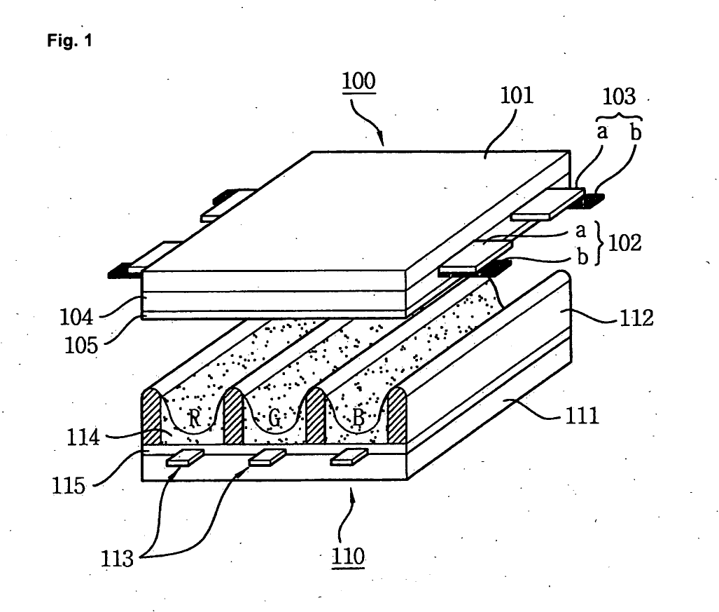

### DETAILED DESCRIPTION OF THE PREFERRED EMBODIMENTS

Preferred embodiments of the present invention will be described in a more detailed manner with reference to the drawings.

The plasma display apparatus of the present invention comprises: a plasma display panel including scan electrodes, sustain electrodes and address electrodes intersecting the scan electrodes and the sustain electrodes; a driver for driving the electrodes; and a reset pulse controller for dividing one frame into a plurality of subfield groups including at least one subfield, controlling the driver in the plurality of subfield groups, and adjusting the amplitude of reset pulses applied to the scan electrodes in the reset period of at least one subfield according to a gray level value in at least one subfield group among the plurality of subfield groups.

The plasma display apparatus according to another aspect of the present invention comprises: a plasma display panel including scan electrodes, sustain electrodes and address electrodes intersecting the scan electrodes and the sustain electrodes; a driver for driving the electrodes; and a reset pulse controller for dividing one frame into a plurality of subfield groups including at least one subfield, controlling the driver in the plurality of subfield groups, and making the amplitude of reset pulses applied to the scan electrodes in the reset period of low gray level subfields more than that in the other subfields.

The plasma display apparatus according to yet another aspect of the present invention comprises: a plasma display panel including scan electrodes, sustain electrodes and address electrodes intersecting the scan electrodes and the sustain electrodes; a driver for driving the electrodes; and a reset pulse controller for dividing one frame into a plurality of subfield groups including at least one subfield, controlling the driver in the plurality of subfield groups, and making the amplitude of reset pulses applied to the scan electrodes in the reset period of a high gray level subfield smaller than that in the other subfields.

The reset pulse controller allows the amplitude of reset pulses to have three or more different voltage values within at least one subfield group.

The reset pulse controller makes the reset pulses with three or more different voltage values within at least one subfield group greater as gray level values of corresponding subfields decrease.

The reset pulse controller sets the amplitude of at least one of the reset pulses within at least one subfield group to a voltage more than two times the sustain voltage Vs.

The subfields in which the amplitude of a reset pulse has a voltage more than two times the sustain voltage Vs are the subfields whose number of sustain pulses is the lowest to the fourth lowest supplied in a sustain period within one subfield group in the order of the lowest number of sustain pulses.

The subfields in which the amplitude of reset pulses have a voltage more than two times the sustain voltage Vs are the subfields supplying a number of sustain pulses that is less than ½ of the total number of sustain pulses of the subfields having the largest number of sustain pulses supplied in the sustain period within one frame.

The subfields in which the amplitude of reset pulses have a voltage more than two times the sustain voltage Vs are the subfields supplying a number of sustain pulses that is less than 20% of the total number of sustain sets pulses of one frame.

The reset pulse controller sets the amplitude of at least one of the reset pulses within at least one subfield group to a voltage ranging from one to two times the sustain voltage Vs.

The subfields in which the amplitude of reset pulse has a voltage ranging from 1 to 2 times the sustain voltage Vs are the subfields whose number of sustain pulses is the highest to fourth highest supplied in a sustain period within one subfield group in decreasing number of the number of sustain pulses.

The subfields in which the amplitude of reset pulses have a voltage ranging from 1 to 2 times the sustain voltage Vs are the subfields supplying a number of sustain pulses that is more than ½ of the total number of sustain pulses of the subfields having the largest number of sustain pulses supplied in the sustain period within one frame.

The subfields in which the amplitude of reset pulses have a voltage ranging from 1 to 2 times the sustain voltage Vs are the subfields supplying a number of sustain pulses that is more than 20% of the total number of sustain pulses of one frame.

The reset pulse controller sets at least one of the reset pulses within at least one subfield group to maintain a positive voltage of a predetermined amplitude and then fall with a slope.

The positive voltage of the predetermined amplitude is a sustain voltage Vs.

The subfields within at least one subfield group are arranged irregularly in the order of gray level values.

An idle period having a predetermined time duration is further comprised between the frames and the subfield groups of the frames are consecutive within the same frame.

A first idle period having a predetermined time duration is comprised between the frames, and a second idle period having a predetermined time duration is further comprised between the subfield groups within the same frame.

The time duration of the first idle period and of the second idle period is the same.

Each of the plurality of subfield groups comprises a plurality of subfields, and the plurality of subfield groups are arranged in increasing order of gray level values.

Each of the plurality of subfield groups comprises a plurality of subfields, and the plurality of subfield groups are arranged in decreasing order of gray level values.

Each frame is divided into two subfield groups, each of the two subfield groups comprises a plurality of subfields, and the two subfield groups are arranged in the order of the amplitude of different gray level values of the subfields within each subfield group.

The subfields of one of the two subfield groups are arranged within the group in increasing order of the amplitude of the gray level values.

The subfields of one of the two subfield groups are arranged within the group in decreasing order of the amplitude of the gray level values.

The subfields of one of the two subfield groups are arranged within the group in decreasing order of the amplitude of the gray level values, and the subfields of one of the two subfield groups are arranged within the group in increasing order of the amplitude of the gray levels.

Hereinafter, embodiments of the present invention will be described in detail with reference to the accompanying drawings.

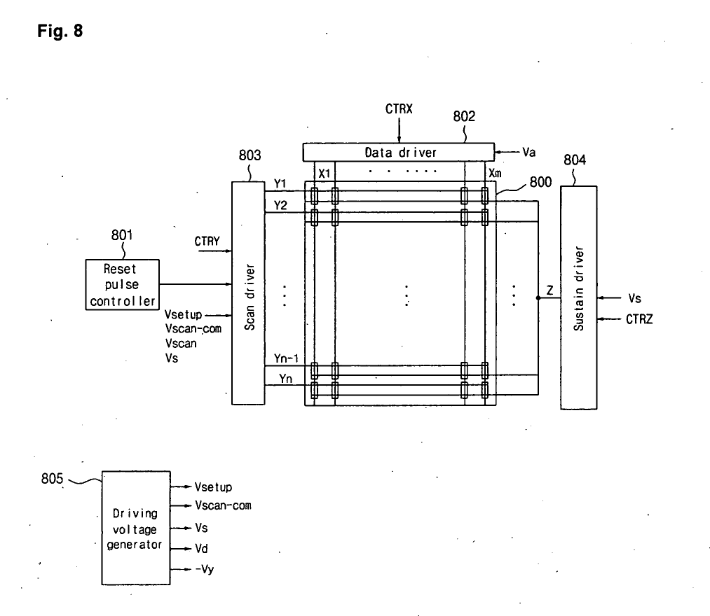

FIG. 8 explains a plasma display apparatus according to the present invention.

As shown in FIG. 8, the plasma display apparatus of the present invention comprises a plasma display panel 800 and a driving apparatus including a data driver 802, a scan driver 803, a sustain driver 804 and a reset pulse controller 801 and supplying driving pulses.

For example, as shown in FIG. 8, the plasma display apparatus of the invention comprises a plasma display panel 800 for expressing an image composed of frames by a combination of at least one subfield applying driving pulses to address electrodes X1 to Xm, scan electrodes Y1 to Yn and sustain electrodes Z in a reset period, address period and sustain period, a data driver 802 for supplying data to the address electrodes X1 to Xm formed on the plasma display panel 800, a scan driver 803 for driving the scan electrodes Y1 to Yn, a sustain driver 804 for driving the sustain electrodes Z as common electrodes, a reset pulse controller 801 for adjusting the amplitude of reset pulses by controlling the scan driver 803 upon driving the plasma display panel 800, and a driving voltage generator 805 for supplying a driving voltage to each of the drivers 802, 803 and 804.

The plasma display apparatus of the present invention expresses an image composed of frames by a combination of at least one subfield applying driving pulses to the address electrodes, scan electrodes and sustain electrodes in the reset period, address period and sustain period, divides each frame into a plurality of subfield groups including at least one subfield, and adjusts the amplitude of reset pulses applied to the scan electrodes in the reset period of one or more subfields of at least one subfield group among these subfield groups according to a gray level value.

In the aforementioned plasma display panel 800, a front panel (not shown) and a rear panel (not shown) are adhered to each other at a predetermined distance, a plurality of electrodes, for instance, the scan electrodes Y1 to Yn and the sustain electrodes Z are formed in pairs, and the address electrodes X1 to Xm are formed to intersect the scan electrodes Y1 to Yn and the sustain electrodes Z.

Data supplied to the data driver802 undergoes inverse-gamma correction and error diffusion processes by a reverse gamma correction circuit and an error diffusion circuit (not shown) and is then mapped to each subfield by a subfield mapping circuit. The data driver 802 samples and latches the data in response to a timing control signal CTRX from the timing controller (not shown) and supplies the data to the address electrodes X1 to Xm.

The scan driver 803 supplies reset pulses that are adjusted in amplitude according to a gray level value of the subfields to the scan electrodes Y1 to Yn for the reset period under control of the reset pulse controller 801. The scan driver 803 sequentially supplies a scan pulse Sp of a scan voltage (−Vy) to the scan electrodes Y1 to Yn during an address period and supplies a sustain pulse sus to the scan electrodes Y1 to Yn during a sustain period.

The sustain driver 804 supplies a bias voltage of a sustain voltage (Vs) to the sustain electrode Z during a period where the ramp-down waveform Ramp-down is generated and the address period and alternately operates with the scan driver 803 during the sustain period to apply the sustain pulse sus to the sustain electrode Z, under the control of the timing controller (not shown).

The reset pulse controller 801 generates a control signal for controlling the operation timing and synchronization of the scan driver 804 in the reset period and supplies the timing control signal to the scan driver 803 to control the scan driver 803. Particularly, the reset pulse controller 801 supplies a control signal to the scan driver 803 to adjust the amplitude of reset pulses, applied to the scan electrodes in the reset period of one or more subfields of at least one subfield group among the plurality of subfield groups divided from one frame, according to a gray level frame.

The reset pulse controller 801 allows the amplitude of reset pulses to have three or more different voltage values within one subfield group, and supplies a control signal to the scan driver 803 so that the amplitude of the reset pulses with three or more different voltage values decreases as the gray level values of the corresponding subfields decreses.

The data control signal CTRX comprises a sampling clock for sampling a data, a latch control signal, and a switch control signal for controlling an on/off time of an energy recovery circuit and a driving switch element. The scan control signal CTRY comprises a switch control signal for controlling an on/off time of an energy recovery circuit and a driving switch element within the scan driver 803. The sustain control signal CTRZ comprises a switch control signal for controlling an on/off time of an energy recovery circuit and a driving switch element within the sustain driver 804.

The driving voltage generator 805 generates a set-up voltage Vsetup, a scan common voltage Vscan-com, a scan voltage −Vscan, a sustain voltage Vs, a data voltage Vd and the like. These driving voltages may vary depending on the composition of a discharge gas or the construction of a discharge cell.

The function of the plasma display apparatus of the present invention of FIG. 8 will be more apparent when the driving method is described hereinafter.

Although not shown, the structure of a plasma display apparatus according to another aspect of the present invention is the same as the plasma display apparatus of the present invention of FIG. 8. Except, the reset pulse controller 801 generates a control signal for controlling the operation timing and synchronization of the scan driver 804 in the reset period and supplies the timing control signal to the scan driver 803 to control the scan driver 803, and particularly, the reset pulse controller 801 supplies a control signal to the scan driver 803 so that the amplitude of the reset pulses, applied to the scan electrodes in the reset period in low gray level subfields of at least one subfield group among the plurality of subfield groups divided from one frame, may be more than in the other subfields.

The function of the plasma display apparatus according to another aspect of the present invention having this structure will be more apparent when the driving method is described hereinafter.

Although not shown, the structure of a plasma display apparatus according to yet another aspect of the present invention is the same as the plasma display apparatus of the present invention of FIG. 8. Except, the reset pulse controller 801 generates a control signal for controlling the operation timing and synchronization of the scan driver 804 in the reset period and supplies the timing control signal to the scan driver 803 to control the scan driver 803, and particularly, the reset pulse controller 801 supplies a control signal to the scan driver 803 so that the amplitude of reset pulses, applied to the scan electrodes in the reset period in high gray level subfields of at least one subfield group among the plurality of subfield groups divided from one frame, may be less than in the other subfields.

The function of the plasma display apparatus according to yet another aspect of the present invention having this structure will be more apparent in the driving method is described hereinafter.

The structure of a plasma display apparatus according to still another aspect of the present invention is the same as the plasma display apparatus of the present invention of FIG. 8. Except, the reset pulse controller 801 generates a control signal for controlling the operation timing and synchronization of the scan driver 804 in the reset period and supplies the timing control signal to the scan driver 803 to control the scan driver 803, and particularly, the reset pulse controller 801 supplies a control signal to the scan driver 803 so that the number of reset pulses, applied to the scan electrodes in the reset period in low gray level subfields of at least one subfield group among the plurality of subfield groups divided from one frame, may be more than in the other subfields.

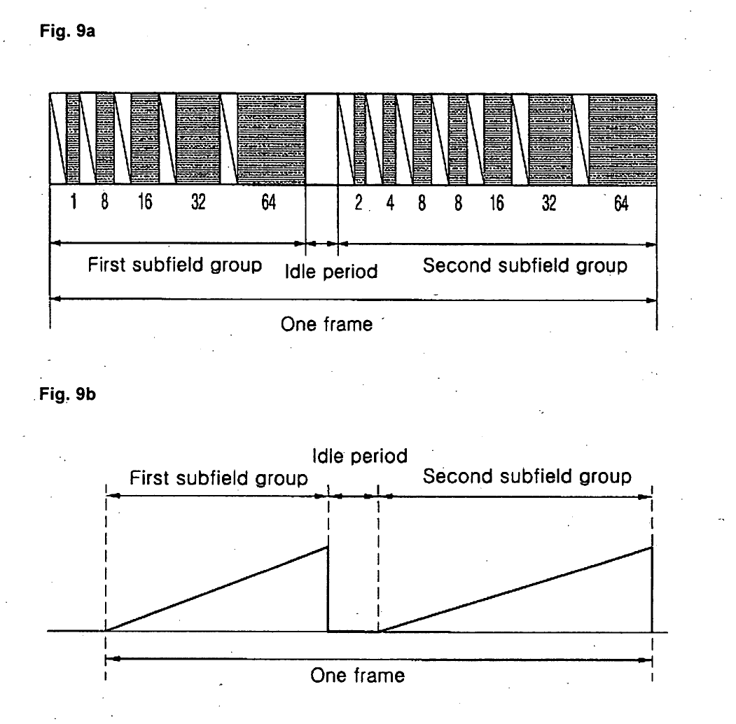

In a first embodiment of a driving method performed by the plasma display apparatus of this invention, one frame is divided into a plurality of subfield groups including at least one subfield, and the amplitude of the reset pulses applied to the scan electrodes Y1 to Yn in the reset period of low gray level subfields in the subfield groups are more than in the other subfields. One example of an arrangement of subfields within one frame in a plurality of stages will be shown as in FIGS. 9a to 9b.

FIGS. 9a and 9b explain one example of dividing one frame into a plurality of subfield groups.

Referring to FIGS. 9a and 9b, in the driving method of a plasma display panel of the present invention, subfields are arranged in two stages by dividing one frame into a plurality of subfield groups, for example, two subfield groups including a first subfield group and a second subfield group as shown in FIG. 9a.

An idle period having a predetermined time duration as shown in FIG. 9b is comprised between the first subfield and the second subfield. That is, one idle period is comprised between the two subfield groups.

The subfields are arranged in increasing order of a weight value, i.e., a gray level value, within each of the groups, that is, the first subfield group and the second subfield group. In other words, the subfield having the lowest weight value, i.e., gray level value is positioned at an initial stage within each of the subfield groups, and then the subfields having a higher weight value are positioned. For example, as in the first subfield group of FIG. 9a, a subfield with a weight of 1, i.e., a gray level value of 1, a subfield of a weight of 8, a subfield of a weight of 16, a subfield with a weight of 32, and a subfield of a weight of 64 are comprised in order.

In the second subfield group, a subfield with a weight of 2, i.e., a gray level value of 2, a subfield of a weight of 4, a subfield of a weight of 8, a subfield of a weight of 16, a subfield with a weight of 32, and a subfield of a weight of 64 are comprised in order.

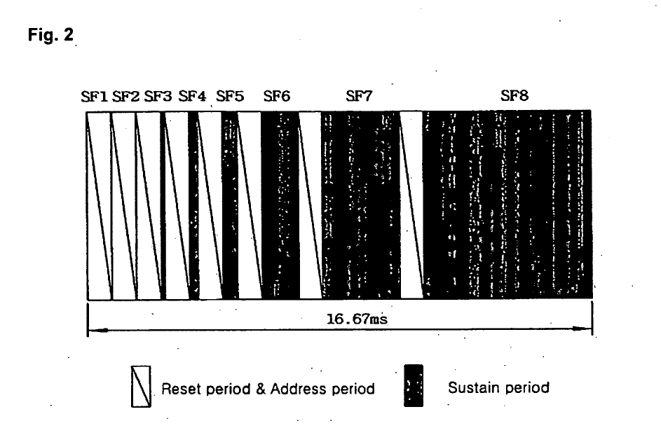

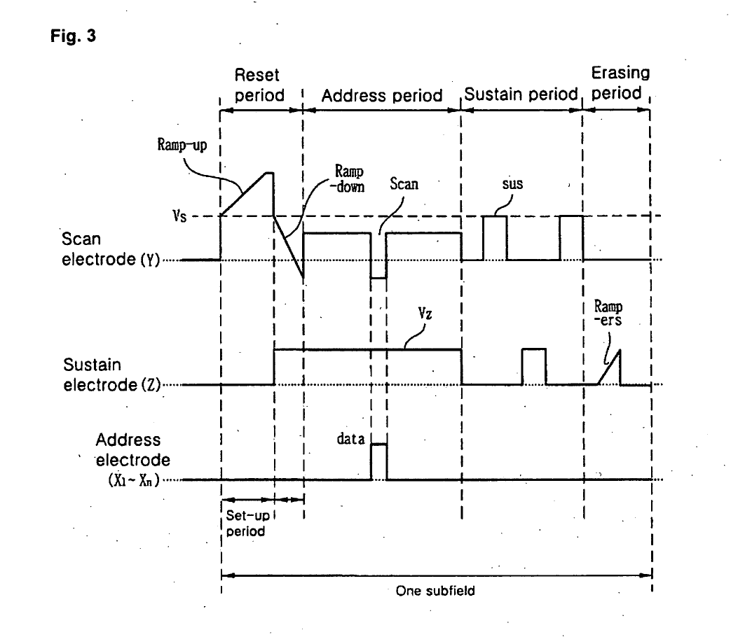

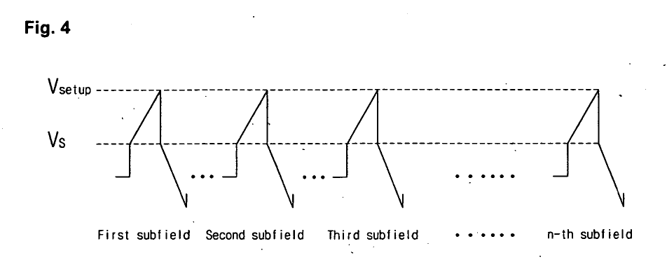

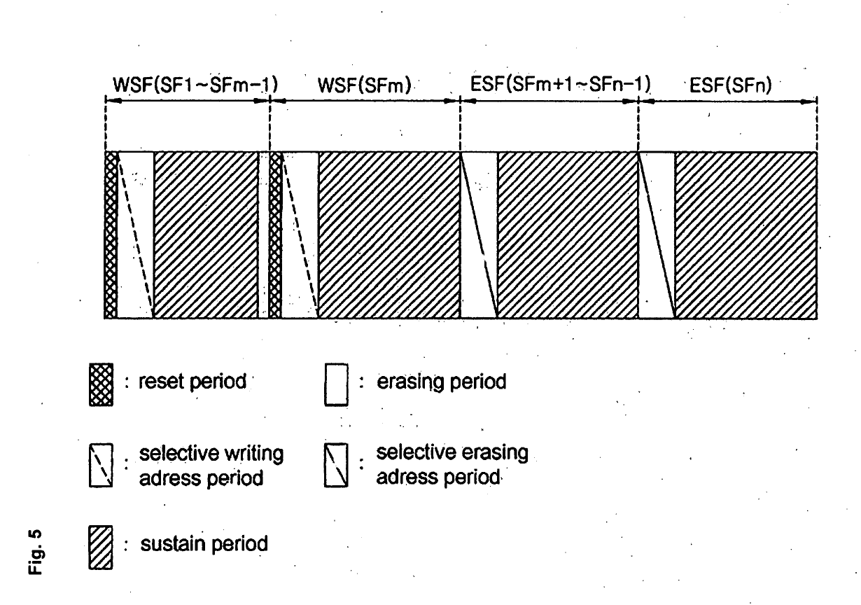

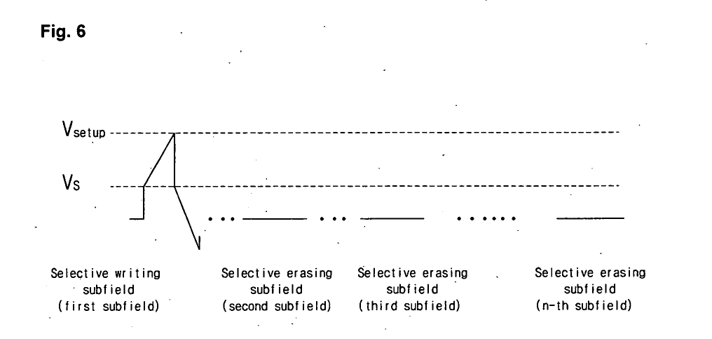

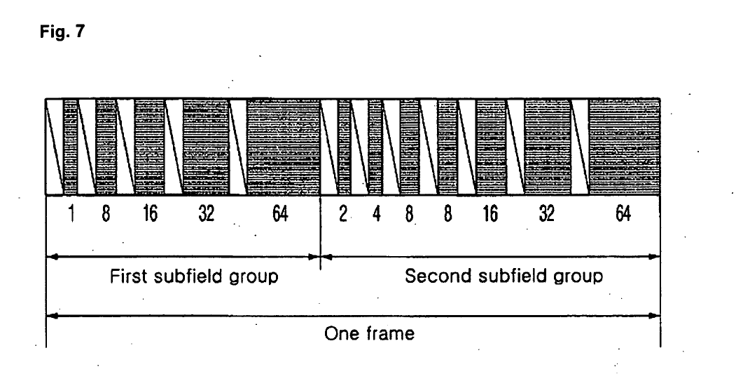

The sum of weights of the arranged subfields within one frame equals to 1+2+4+8+(8+8)+(16+16)+(32+32)+(64+64), i.e., 255. As a result, 256 gray levels can be implemented as in the frame of FIG. 2 in which subfields of weights of 1, 2, 4, 6, 8, 16, 32, 64, and 128 are arranged in order. By including the first subfield group capable of implementing 121 gray levels and the second subfield group capable of 135 gray levels, it is possible to obtain the effect of implementing two frames capable of implementing 121 gray levels and 135 gray levels by means of one frame of 256 gray levels. Therefore, this visually increases the frame frequency two times, thereby reducing flicker. The concept of weights of subfields within one frame and the concept of an idle period are shown in FIG. 9b.

Referring to FIG. 9b, one frame comprises two subfield groups, that is, a first subfield group and a second subfield group, and an idle period is comprised between these subfield groups. The weights of subfields comprised in each of the subfield groups are denoted by triangular symbols. This means that the subfields within each of the subfield group are arranged in increasing order of a gray level value.

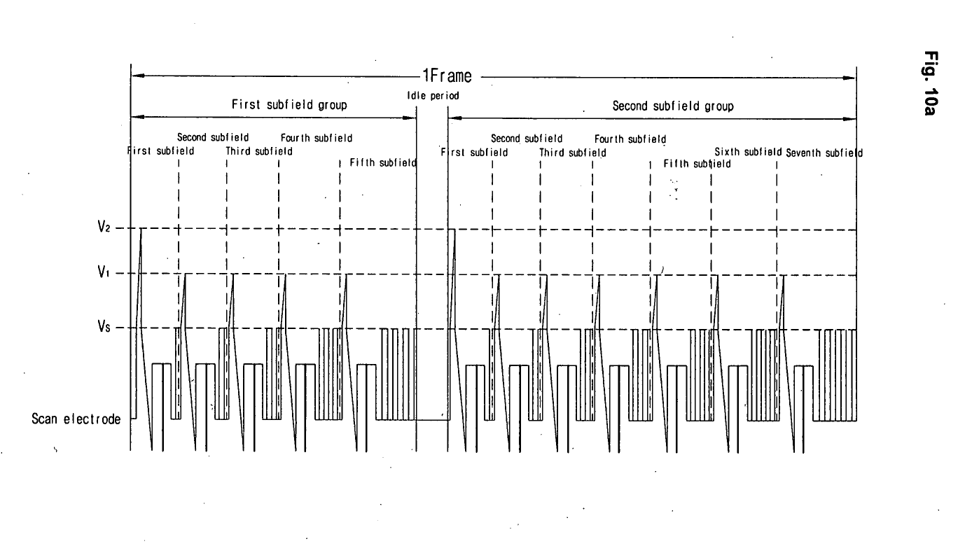

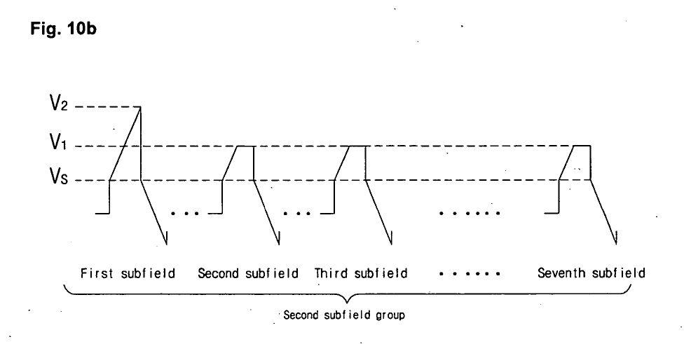

In the method of dividing one frame into a plurality of subfield groups for its driving, the amplitude of the reset pulses applied to the scan electrodes in the reset period of one subfield having a low weight value, i.e., a relatively low gray level value, that is, a low gray level subfield is adjusted. One example of such a driving method is as shown in FIGS. 10a and 10b.

FIGS. 10a and 10b explain a first embodiment of a driving method of a plasma display panel according to the present invention.

As shown in FIGS. 10a and 10b, in a first embodiment of a driving method of a plasma display panel including scan electrodes, sustain electrodes, and a plurality of address electrodes intersecting the scan electrodes and the sustain electrodes, one frame is divided into a plurality of subfield groups including at least one subfield, and in at least one of the divided subfield groups, the amplitude of the reset pulses applied to the scan electrodes in the reset period of low gray level subfields are more than in the other subfields.

For example, When one frame is divided into two subfield groups, i.e., a first subfield group and a second subfield group as shown in FIG. 10a, the amplitude V2 of the reset pulses, applied to the scan electrodes in the reset period of the foremost subfields implementing the lowest gray level due to its lowest weight value in each of the subfield groups, that is, the first subfield in the first subfield group and the first subfield in the second subfield group, is more than the amplitude V1 of the reset pulses in the other subfields, that is, the second, third, fourth and fifth subfields of the first subfield group and the second, third, fourth and fifth subfields of the second subfield group. In FIG. 10a, the amplitude of the reset pulses of one subfield of every subfield groups, i.e., both first subfield group and second subfield group, of one frame are more than in the other subfields. However it is also possible to adjust the amplitude of reset pulses only in some selected subfield group among the plurality of subfield groups, for example, in either one of the first subfield group and the second subfield group of FIG. 10a.

Preferably, the amplitude V2 of the reset pulses applied to the scan electrodes in the reset period of low gray level subfields has a voltage more than two times the sustain voltage Vs, that is, more than 2Vs.

The reason why the amplitude of the reset pulses in low gray level subfields of at least one subfield group are more than in the other subfields, preferably, has a voltage higher than 2Vs is as follows.

Low gray level subfields implementing low gray levels have a higher probability of creating an address discharge unstable than subfields implementing high gray levels. As a consequence, if the amplitude of the reset pulses applied to the scan electrodes in the reset period is too low, wall charges are not uniformly distributed within discharge cells, and thus a subsequent address discharge is made unstable, thereby creasing address jitter to deteriorate and making a subsequent sustain discharge unstable.

The number of low gray level subfields causing an unstable discharge increases in the PAL method in which one frame is divided into a plurality of subfield groups for its driving. For example, in the event that subfields with a weight of less than 10, that is, a gray level value of less than 10, are set as low gray level subfields, in the prior art driving method of FIG. 2, the low gray level subfields comprise a first subfield with a gray level of 1, a second subfield of a gray level of 2, a third subfield of a gray level of 4, and a fourth subfield of a gray level of 8, that is, a total of four low gray level subfields. In the driving method of FIG. 10a, the low gray level subfields with a weight of less than 10, that is, a gray level of less than 10, comprise a first subfield of a gray level of 1 and a second subfield of a gray level of 8 in the first subfield group and a first subfield of a gray level of 2, a second subfield of a gray level of 4, a third subfield of a gray level of 8 and a fourth subfield of a gray level of 8. In other words, the number of low gray level subfields is more in the PAL method.

Therefore, in the PAL method in which more low gray level subfields are comprised, the amplitude of the reset pulses applied in the reset period of low gray level subfields implementing low gray levels is more than 2 Vs, thereby suppressing flicker and stabilizing an address discharge in the low gray level subfields implementing low gray levels. Once the address discharge is stabilized, the deterioration of the driving margin of the entire plasma display apparatus is suppressed.

A reset pulse of FIG. 10a whose amplitude is adjusted according to a gray level value of a subfield is shown in more detail in FIG. 10b.

Referring to FIG. 10b, the amplitude V2 of the reset pulse in the first subfield in the second subfield group is the largest, and the amplitude of the reset pulse in the other subfields is less than the amplitude of reset pulse in the first subfield. In FIG. 10b, the slope of the rising ramp Ramp-up of reset pulse in the first subfield is the same as the slope of the rising ramp Ramp-up of reset pulse in the second, third, fourth, fifth, sixth, seventh and eighth subfields, but the amplitude of the largest voltage value thereof are different from each other. If every subfield has a rising ramp with the same slope, it is possible to generate a rising ramp in every subfield from the first to eighth subfields by using the set-up pulse generating circuit (not shown) from a viewpoint of a structure of a circuit generating a rising ramp, and make control easier.

The above-described low gray level subfields can be determined according to the number of sustain pulses supplied in the sustain period. For example, it is preferable that low gray level subfields are the subfields supplying sustain pulses less than ½ of the total number of sustain pulses of the subfields having the largest number of sustain pulses supplied in the sustain period within one frame. For example, if the subfield having the largest number of sustain pulses among the subfields comprised in one frame comprises a total of 1000 sustain pulses, the subfields including less than 500 sustain pulses are set as low gray level subfields.

However, it is also possible to set the subfields supplying sustain pulses less than 20% of the total number of sustain pulses of one frame as low gray level subfields. For example, if the number of sustain pulses supplied within one frame is 2000, the subfields supplying less than 400 sustain pulses are set as the low gray level subfields.

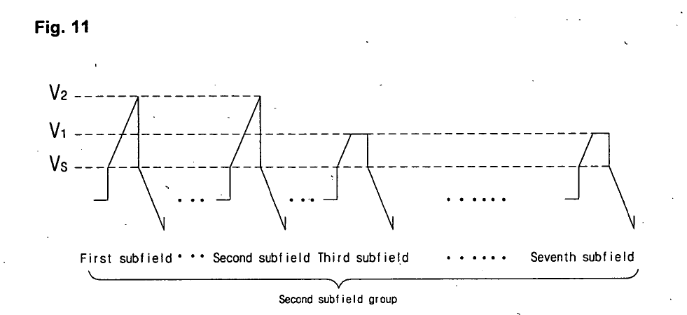

It is also possible to set the low gray level subfields in the order of the smallest number of sustain pulses within one subfield group. One example of setting low gray level subfields will be shown in FIG. 11.

FIG. 11 explains one example of a low gray level subfield setting method in the first embodiment of the driving method of the plasma display panel according to the present invention.

As shown in FIG. 11, a plurality of subfields are set as low gray level subfields in one subfield group. Although FIG. 11 illustrates two subfields as being set as low gray level subfields, it is preferable that in the present invention, the subfields whose number of sustain pulses is the lowest to the fourth lowest are set as low gray level subfields within one subfield group in the order of the lowest number of sustain pulses. For example, if a total of 7 subfields comprises the second subfield group as shown in FIG. 10a, the first subfield implementing the lowest gray level due to its lowest number of sustain pulses, that is, the lowest weight value, and the next subfields, including the second, third and fourth subfields, are set as low gray level subfields.

As described above, the amplitude of the reset pulses in the low gray level subfields more than the amplitude of the reset pulses in the other subfields. That is, as shown in FIG. 11, the amplitude of reset pulses applied to the scan electrodes in the reset period of the first and second subfields set as the low gray level subfields is more than the amplitude of the reset pluses in the other subfields. For example, is set as a voltage V2 of higher than 2Vs, and the amplitude of reset pulses applied to the scan electrodes in the reset period of the other subfields is set as V1, which is lower than the voltage V2.

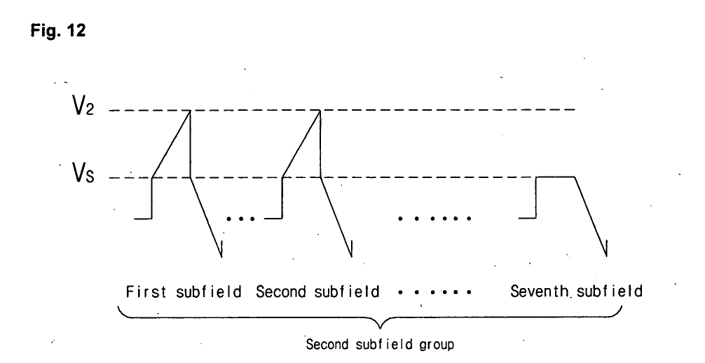

In the above explanation, a rising ramp Ramp-up rising with a given slope is also comprised in the subfields other than the low gray level subfields, that is, the third to seventh subfields of the second subfield group of FIG. 11. However, it is also possible to apply a reset pulse in a manner that the rising ramp may not be comprised in the reset period of one subfield of at least one subfield group. Such a driving waveform will be shown in FIG. 12.

FIG. 12 explains another driving waveform according to the first embodiment of the driving method of the plasma display panel according to the present invention.

As shown in FIG. 12, in another driving waveform according to the first embodiment of the driving method of the plasma display panel according to the present invention, a rising ramp Ramp-up rising with a given slope is omitted in a reset pulse applied to the scan electrodes in the reset period of at least one of the subfields comprised within one subfield group. For example, as shown in FIG. 12, a reset pulse in the seventh subfield of the second subfield group has a falling ramp waveform Ram-down maintaing a positive voltage of a predetermined amplitude and then falling with a slope. The reset pulse of the seventh subfield has no rising ramp when compared with a reset pulse applied to the scan electrodes in the reset period of the other subfields, that is, the first to sixth subfields, keeps a positive voltage in the seventh subfield in a period a rising ramp is applied in the other subfields, and then has a falling ramp waveform.

Preferably, the subfield applying a reset pulse with no rising ramp is a high gray level subfield implementing a high gray level. Accordingly, the amount of an unnecessary discharge not contributing to an image display is further reduced in the reset period of a high gray level subfield generating a relatively stable discharge, unlike the low gray level subfield, thereby further improving the contrast.

From a viewpoint of a driving circuit, there is no need to supply a set-up voltage having a pulse form of a rising ramp, which makes it easier to control the driving circuit.

A rising ramp with a relatively high voltage is not supplied, to thus reduce power consumption.

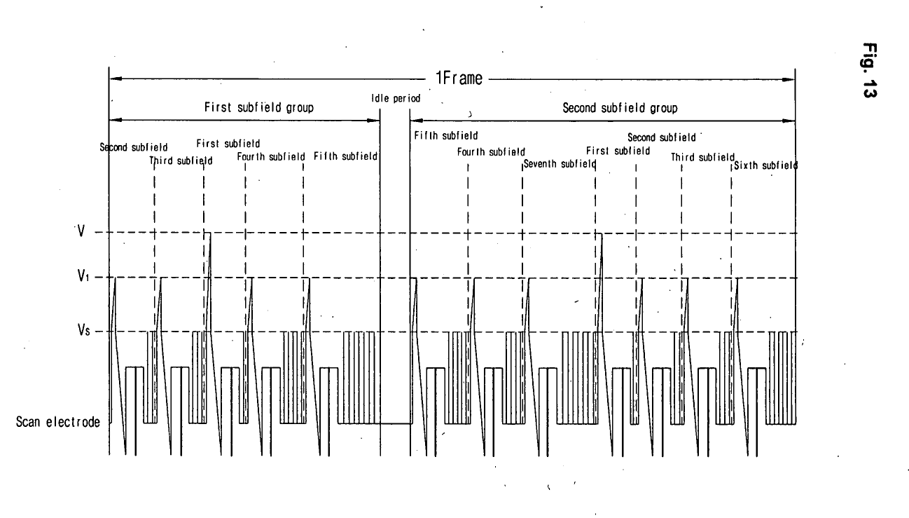

Although one example described above showed where subfields comprised in one subfield group are uniformly arranged in the order of a weight value, that is, a gray level value, it is also possible to arrange subfields irregularly in one subfield group. Such an example of a driving method will be shown in FIG. 13.

FIG. 13 explains an arrangement of subfields within one subfield group in the first embodiment of the driving method of the plasma display panel according to the present invention.

As shown in FIG. 13, subfields within at least one subfield group are not regularly arranged in the order of a weight value, i.e., in the order of a gray level value, but are randomly arranged regardless of a gray level value. Even within the subfield group having such an irregular subfield arrangement, the amplitude of reset pulses applied to the scan electrodes in the reset period in the third foremost subfield of the first subfield group, which is a low gray level subfield in the first subfield is more than the amplitude of the reset pluses in the other subfields, and the amplitude of reset pulses applied to the scan electrodes in the reset period of the fourth foremost subfield of the second subfield group, that is, of the first subfield is more than in the other subfields.

When comparing of FIG. 13 with FIG. 10a, if the subfield arrangement of FIG. 10a is in the order of the first, second, third, fourth and fifth subfields within the first subfield group, and in the order of the first, second, third, fourth, fifth, sixth and seventh subfields within the second subfield group, the subfield arrangement of FIG. 13 is in the order of the second, third, first, fourth and fifth subfields within the first subfield group and in the order of the fifth, fourth, seventh, first, second, third and sixth subfields within the second subfield group. Although in FIG. 13, the subfields are randomly arranged regardless of a weight value, i.e., a gray level value, within one subfield group, it is also possible to alternately arrange high gray level subfields having a relatively high weight value, i.e., a high gray level value, and low gray level subfields having a relatively low weight value, i.e., a low gray level value within one subfield group. The present invention is not limited by the above-described order of subfield arrangement, even if the present invention has a certain subfield arrangement of a subfield group, it is most important to make the amplitude of reset pulses, applied to the scan electrodes in the reset period of low gray level subfields among the subfields comprise in the subfield group, more than in the other subfields.

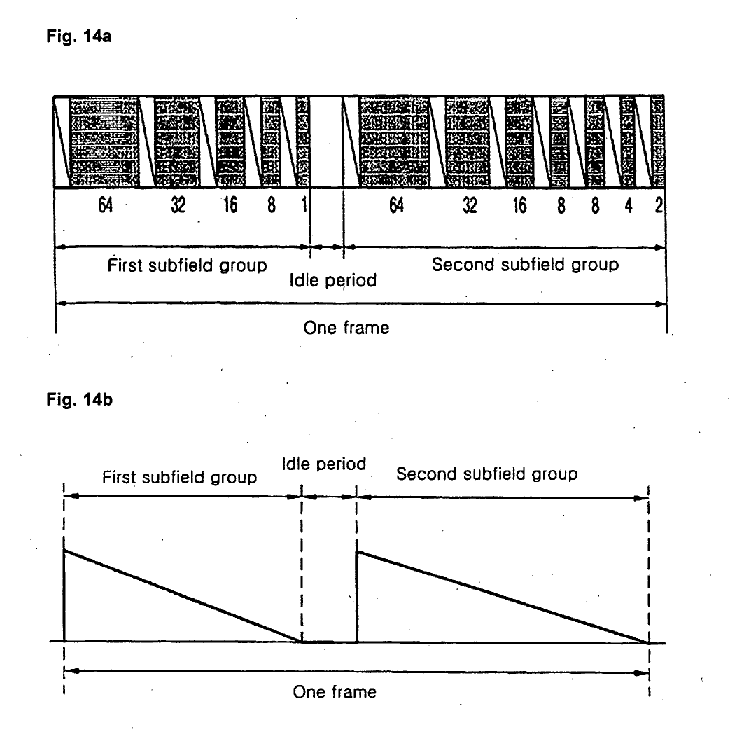

The above description concerns the arrangement of subfields within one subfield group in increasing order of a weight value, i.e., a gray level value, However it is also possible to arrange subfields within at least one subfield group in decreasing order of a gray level value. This will be shown in FIGS. 14a and 14b.

FIGS. 14a and 14b explain another example of dividing one frame into a plurality of subfield groups.

Referring to FIGS. 14a and 14b, one frame is divided into a plurality of subfield groups, and subfields are arranged within at least one subfield group in decreasing order of a weight value, i.e., a gray level value.

For example, as shown in FIG. 14a, when one frame is divided into two subfield groups, the subfields are arranged within each of the groups, that is, the first subfield group and the second subfield group, in decreasing order of a weight value, i.e., a gray level value. The subfields implementing the highest gray level are positioned at an early stage of each subfield group. That is, the first subfield group or the second subfield group, the subfields having a lower weight value, i.e., a lower gray level value are positioned. For example, a subfield with a weight of 64, a subfield with a weight of 32, a subfield with a weight of 16, a subfield with a weight of 8 and a subfield with a weight of 1 are sequentially comprised in the first subfield group.

In the second subfield group, a subfield with a weight of 64, a subfield with a weight of 32, a subfield with a weight of 16, two subfields with a weight of 8, a subfield with a weight of 4, and a subfield with a weight of 2 are sequentially comprised. The concept of weights of subfields within one frame and the concept of an idle period are shown in FIG. 14b.

Referring to FIG. 14b, one frame comprises two subfield groups, that is, a first subfield group and a second subfield group, and an idle period is comprised between these subfield groups. The weights of subfields comprised in each of the subfield groups are denoted by triangular symbols. This means that the subfields within each of the subfield group are arranged in increasing order of a gray level value.

An idle period having a predetermined time duration is also comprised between the first subfield group and the second subfield group.

The sum of weights of the arranged subfields within one frame equals to 1+2+4+8+(8+8)+(16+16)+(32+32)+(64+64), i.e., 255, which is the same as in FIG. 9a. As a result, subfields of weights of 1, 2, 4, 6, 8, 16, 32, 64, and 128 are arranged in a reverse order of gray level values, to implement a total weight value, i.e., a total gray level value of 256 gray levels as in the frame of FIG. 2. By including the second subfield group capable of implementing 121 gray levels and the first subfield group capable of 135 gray levels, it is possible to obtain the effect of two frames capable of implementing 121 gray levels and 135 gray levels. Therefore, flicker is reduced. Such a driving method of a subfield arrangement type is substantially the same as in FIG. 9a except that the subfields are arranged in a reverse order, thus a repetitive explanation will be omitted.

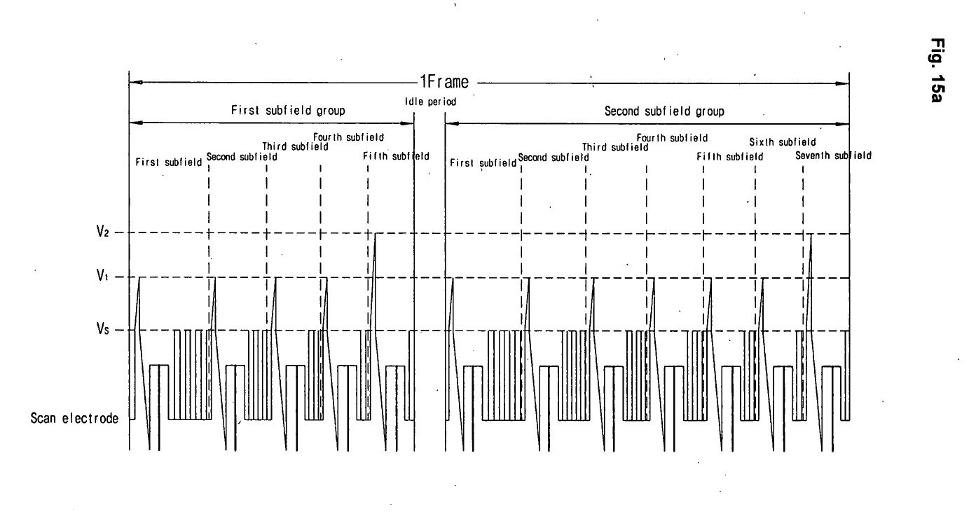

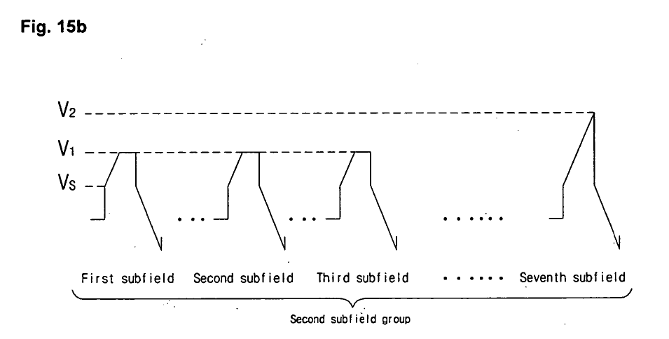

In the method of dividing one frame into a plurality of subfield groups for its driving, in the event that the subfields are arranged within one subfield group in a reverse order of a gray level value, the amplitude of reset pulses applied to the scan electrodes in the reset period of one subfield having a low weight value, i.e., a relatively low gray level value, that is, a low gray level subfield is adjusted. One example of such a driving method is as shown in FIGS. 15a and 15b.

FIGS. 15a and 15b explain one example of a driving waveform in the driving method having the arrangement order of FIGS. 14a and 14b.

As shown in FIGS. 15a and 15b, the order of arrangement of the subfields within each subfield group is opposite to the arrangement of FIG. 10a. That is, the subfields are arranged in a reverse order of gray level values.

As shown in FIG. 15a, in the event that one frame is divided into two subfield groups, that is, a first subfield group and a second subfield group, the amplitude V2 of the reset pulses, applied to the scan electrodes in the reset period of the last subfield implementing the lowest gray level due to its lowest weight value, that is, of the fifth subfield in the first subfield group and of the seventh subfield in the second subfield group, is more than the amplitude V1 of the reset pulses in the other subfields, that is, in the first, second, third and fourth subfields of the first subfield group and in the first, second, third, fourth, fifth and sixth subfields of the second subfield group.

A reset pulse of FIG. 15a whose amplitude is adjusted according to a gray level value of a subfield is shown in more detail in FIG. 15b.

Referring to FIG. 15b, the amplitude V2 of reset pulse in the seventh subfield in the second subfield group is the largest, and the amplitude of the reset pulse in the other subfields is less than the amplitude of reset pulse in the seventh subfield. Preferable the slope of the rising ramp Ramp-up of reset pulse in the seventh subfield is the same as the slope of the rising ramp Ramp-up of reset pulse in the first, second, third, fourth, fifth and sixth subfields. But the amplitude of the largest voltage value thereof is different from each other. The driving waveform of FIGS. 15a and 15b are substantially the same as that in FIGS. 10a and 10b except that the subfield are arranged in a reverse order, thus a repetitive explanation will be omitted.

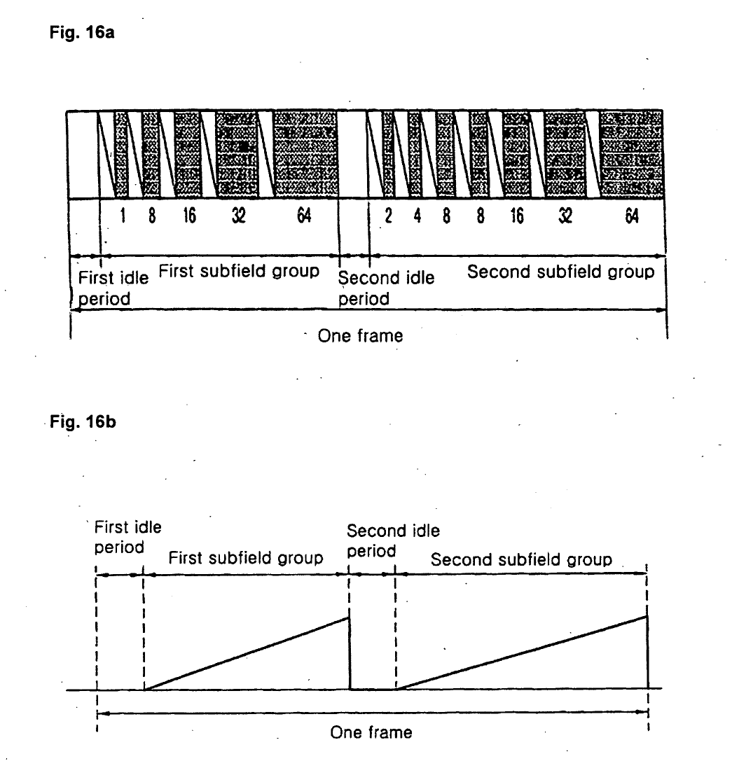

In the above description of the first embodiment of the driving method according to the present invention, one frame is divided into a plurality of subfield groups, and one idle period is comprised between the plurality of divided subfield groups. In other words it is also possible to further comprise an idle period having a predetermined time duration between the subfield groups as well as between frames. Such a driving method will be shown in FIGS. 16a and 16b.

FIGS. 16a and 16b explain another example of dividing one frame into a plurality of subfield groups.

Referring to FIGS. 16a and 16b, a first idle period having a predetermined time duration is comprised at the front end of frames, and a second idle period having a predetermined time duration is comprised between the first subfield group and the second subfield group, while in FIG. 9a an idle period having a predetermined time duration is comprised between the first subfield group and the second subfield group.

Referring to FIG. 16a, The subfields of one frame are divided into a plurality of groups, preferably, two subfield groups including a first subfield group and a second subfield group, and they are arranged within each subfield group in increasing order of a weight value, i.e., of a gray level value. That is, the subfields having the lowest weight value are positioned at an early stage of each subfield group, and as they go further, the subfields having a higher weight value are positioned. For example, as shown in FIG. 16a, a subfield with a weight of 1, a subfield with a weight of 8, a subfield with a weight of 16, a subfield with a weight of 32, and a subfield with a weight of 64 are sequentially comprised in the first subfield group. Further, a subfield with a weight of 2, a subfield with a weight of 4, two subfields with a weight of 8, a subfield with a weight of 16, a subfield with a weight of 32, and a subfield with a weight of 64 are sequentially comprised in the second subfield group.

A second idle period having a predetermined time duration is comprised between the subfield groups thus arranged, and a first idle period having a predetermined time duration is comprised between the frames. The first idle period and the second idle period may have the same or different time duration. However, preferably, the time duration of the first idle period and second idle period are the same in consideration of the effect of visual division between each subfield group and the ease of driving control.

In the first idle period between the frames and the second idle period between the subfield groups, the visual effect of recognizing one frame as two frames is increases. Thus, flicker is further reduced to improve the picture quality. The driving method of FIGS. 16a and 16b is substantially the same as the driving method of FIGS. 9a and 9b except that one more idle period is added in comparison with FIGS. 9a and 9b, a repetitive explanation thereof will be omitted.

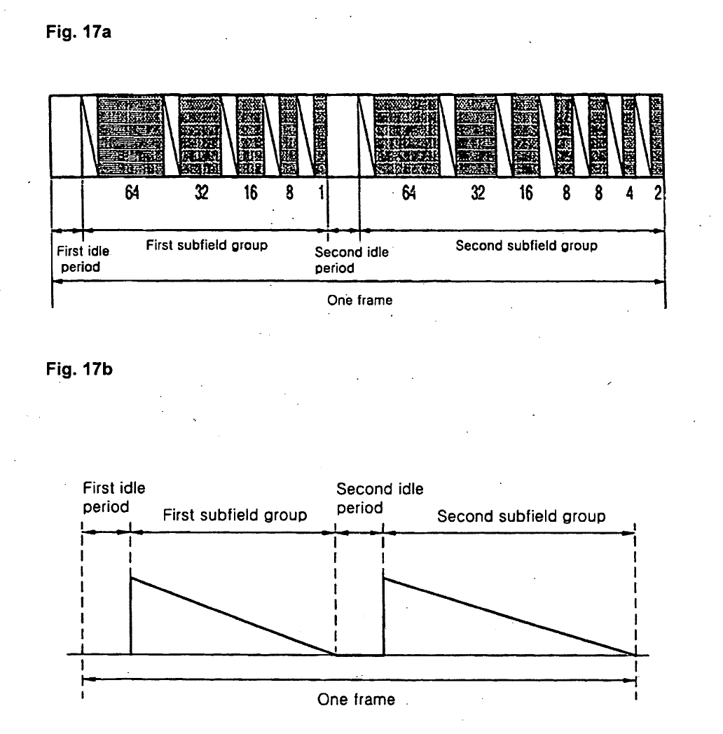

In the first embodiment of the driving method of the plasma display panel according to the present invention, the subfields may be arranged within each subfield group in decreasing order of a weight value, i.e., a gray level value, differently from FIGS. 16a and 16b. Such a driving method will be shown in FIGS. 17a and 17b.

FIGS. 17a and 17b another example of dividing one frame into a plurality of subfield groups.

Referring to FIGS. 17a and 17b, while in FIGS. 16a and 16b, subfields are arranged within the first subfield group and the second subfield group in increasing order of a gray level value, the driving waveform of FIGS. 17a and 17b is substantially the same as that of FIGS. 16a and 16b except that the subfields are arranged in a reverse order, thus a repetitive explanation will be omitted.

Although in the first embodiment of the driving method of the plasma display panel, the amplitude of reset pulses in low gray level subfields among the subfields of one subfield group is adjusted, it is also possible to adjust the amplitude of reset pulses in high gray level subfields among the subfields of one subfield group, which will be described in a second embodiment of the driving method of the plasma display panel according to the present invention.

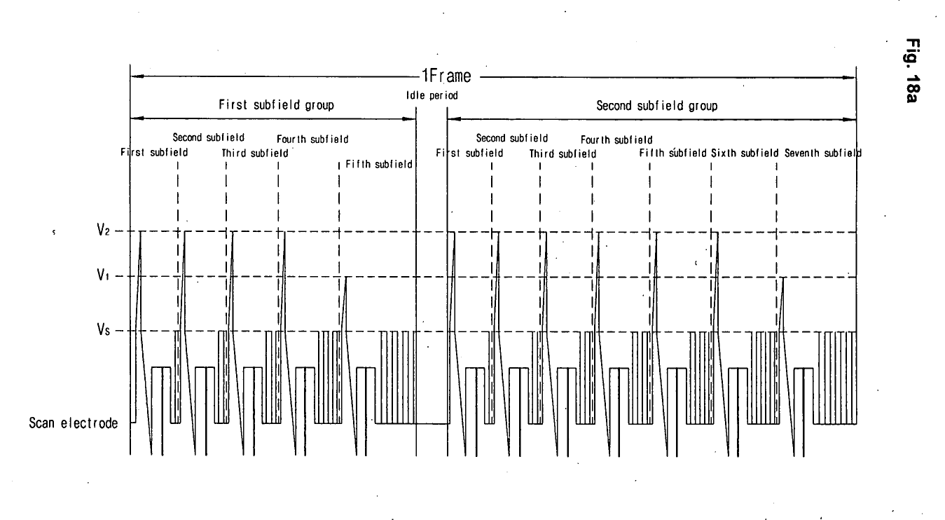

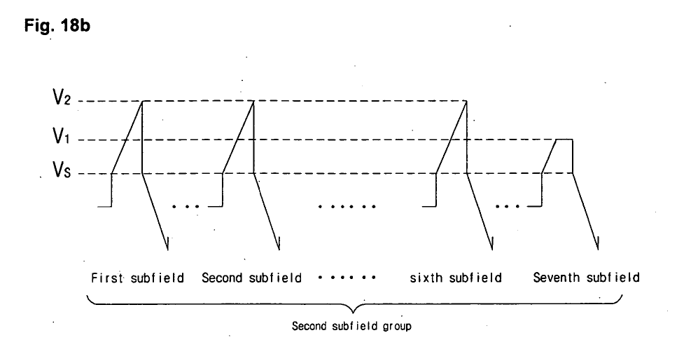

FIGS. 18a and 18b explain a second embodiment of a driving method of a plasma display panel according to the present invention.

As shown in FIGS. 18a and 18b, in the second embodiment of the driving method of the plasma display panel including scan electrodes, sustain electrodes and address electrodes intersecting the scan electrodes and the sustain electrodes, one frame is divided into a plurality of subfield groups including at least one subfield, and the amplitude of reset pulses, applied to the scan electrodes in the reset period of high gray level subfields among the subfields of at least one of the plurality of subfield groups, is less than the amplitude of the reset pluses in the other subfields.

For example, as shown in FIG. 18a, When one frame is divided into two subfield groups, that is, a first subfield group and a second subfield group, the amplitude V1 of the reset pulses, applied to the scan electrodes in the reset period of the last subfield implementing the highest gray level, that is, of the fifth subfield in the first subfield group and the seventh subfield in the second subfield group, is less than the amplitude V2 of the reset pulses in the other subfields, that is, in the first, second, third and fourth subfields of the first subfield group and in the first, second, third, fourth, fifth and sixth subfields of the second subfield group. In FIG. 18a, the amplitude of reset pulses of one subfield of every subfield group, i.e., both the first subfield group and the second subfield group, of one frame is less than the amplitude of the reset pluses in the other subfields. However it is also possible to adjust the amplitude of reset pulses only in some selected subfield group among the plurality of subfield groups, for example, in either one of the first subfield group and the second subfield group of FIG. 18a.

Preferably, the amplitude V1 of the reset pulses applied to the scan electrodes in the reset period of high gray level subfields has a voltage less than two times the sustain voltage Vs, that is, less than 2Vs and higher than the sustain voltage Vs. That is, the relationship of Vs≦V1≦2Vs is established.

The reason why the amplitude of reset pulses in high gray level subfields of one subfield group is less than in the other subfields preferably, has a voltage more than the sustain voltage Vs and less than two times the sustain voltage 2Vs is as follows.

High gray level subfields implementing high gray levels have a relatively higher probability of creating an unstable address discharge than subfields implementing low gray levels. Thus, even if the amplitude of reset pulses applied to the scan electrodes in the reset period is less than in low gray level subfields, wall charges can be uniformly distributed within discharge cells. As a consequence, even if reset pulses of a relatively small voltage are supplied in high gray level subfields, a subsequent address discharge will be relatively stable, thereby suppressing the deterioration of address jitter and preventing a subsequent sustain discharge from being unstable. As a result the width of the scan pulses, applied to the scan electrodes in the reset period in high gray level subfields among the subfields of one subfield group, is less than in the other subfields, thereby stabilizing the discharge characteristics of the plasma display panel and reducing the amount of unnecessary discharge not contributing to an image display generated by reset pulses to improve the contrast.

In the PAL method of driving one frame into a plurality of subfield groups, the number of subfields comprised in one frame increases. For example, in the conventional driving method as shown in FIG. 2, a total of eight subfields are comprised in one frame. In one example of the PAL method as shown in FIG. 18a, five subfields of the first subfield group and seven subfields of the second subfield group, that is, a total of 12 subfields are comprised in one frame, while implementing 256 gray levels as shown in FIG. 2. As a result in case of FIG. 18a, a larger number of reset pulses applied in the reset period is comprised.

As a consequence, in the PAL method, where the number of reset pulses is greater because the number of subfields is relatively more, the amplitude of reset pulses applied in the reset period in high gray level subfields is more than the sustain voltage Vs and less than two times the sustain voltage 2Vs, thereby suppressing flicker and reducing the amount of a dark discharges generated by the reset pulses in the reset period thereby improve the contrast.

A reset pulse of FIG. 18a whose amplitude is adjusted according to a gray level value of a subfield is shown in more detail in FIG. 18b.

Referring to FIG. 18b, the amplitude V1 of a reset pulse in the seventh subfield in the second subfield group is the lowest, and the amplitude of reset pulses in the other subfields are more than the amplitude of reset pulse in the seventh subfield. In FIG. 14b, the slope of the rising ramp Ramp-up of reset pulse in the seventh subfield in the second subfield group is the same as the slope of the rising ramp Ramp-up of reset pulse in the first, second, third, fourth, fifth and sixth subfields, but the amplitude of the largest voltage value thereof is different from each other. If every subfield has a rising ramp with the same slope, it is possible to generate a rising ramp in every subfield from the first to seventh subfields by using the set-up pulse generating circuit (not shown) from a viewpoint of a structure of a circuit generating a rising ramp, and make control easier.

The above-described high gray level subfields can be determined according to the number of sustain pulses supplied in the sustain period of the subfields within one frame. For example, it is preferable that these high gray level subfields are the subfields supplying a number of sustain pulses that is more than ½ of the total number of sustain pulses of the subfields having the largest number of sustain pulses supplied in the sustain period of the subfields comprised in one subfield group. For example, if the subfield having the largest number of sustain pulses among the subfields comprised in one frame comprises a total of 1000 sustain pulses, the subfields including greater than 500 sustain pulses are set as high gray level subfields.

However it is also possible to set the subfields supplying a number of sustain pulses that is than 20% of the total number of sustain pulses of one frame as high gray level subfields. For example, if the number of sustain pulses supplied within one frame is 2000, the subfields supplying greater than 400 sustain pulses are set as high gray level subfields.

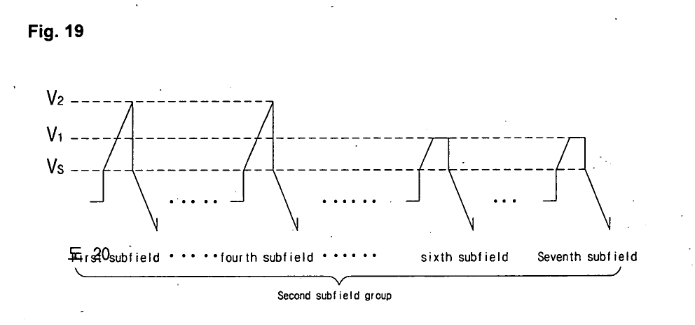

It is possible to set high gray level subfields in the order of the largest number of sustain pulses within one subfield group. One example of setting high gray level subfields will be shown in FIG. 19.

FIG. 19 explains one example of a high gray level subfield setting method in the second embodiment of the driving method of the plasma display panel according to the present invention.

As shown in FIG. 19, a plurality of subfields among the subfields comprised in one subfield group are set as high gray level subfields. Although FIG. 19 illustrates two low gray level subfields as being comprised in one subfield group, it is preferable that the subfields whose number of sustain pulses supplied in the sustain period among the plurality of subfields is the largest to the fourth largest are set as high gray level subfields within one subfield group in decreasing order of the number of sustain pulses. For example, if a total of 7 subfields comprises one subfield group as in the second subfield group of FIG. 18a, the seventh subfield implementing the highest gray level due to its largest number of sustain pulses, that is, the highest weight value, and the next subfields including the sixth, fifth and fourth subfields are set as high gray level subfields in decreasing order of the number of sustain pulses.

As described above, the amplitude of the reset pulses in the high gray level subfields are less than the amplitude of the reset pluses in the other subfields. That is, as shown in FIG. 19, the amplitude of reset pulses applied to the scan electrodes in the reset period of the sixth and seventh subfields set as the high gray level subfields is less than in the other subfields. For example, is set as a voltage V1 which is more than the sustain voltage Vs and less than two times the sustain voltage 2Vs, and the amplitude of reset pulses applied to the scan electrodes in the reset period of the other subfields is set as V2, which is more than the voltage V2.

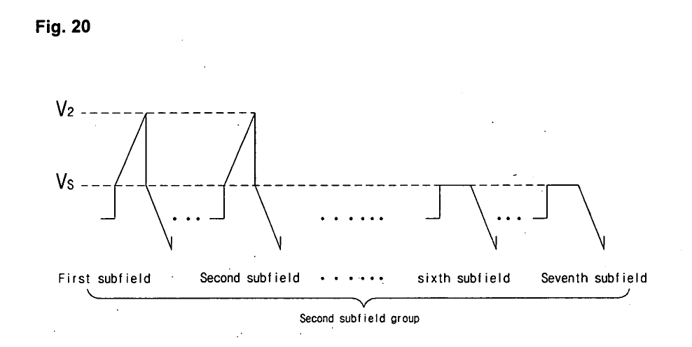

In the above explanation, a rising ramp, Ramp-up rising with a given slope is also comprised in the high gray level subfields, that is, the sixth to seventh subfields of the second subfield group of FIG. 19. However, it is also possible to apply a reset pulse in a manner that the rising ramp may not be comprised in the reset period of one or more subfields of the subfield groups. Such a driving waveform will be shown in FIG. 20.

FIG. 20 explains another driving waveform according to the second embodiment of the driving method of the plasma display panel according to the present invention.

As shown in FIG. 20, in another driving waveform according to the second embodiment of the driving method of the plasma display panel according to the present invention, a rising ramp Ramp-up rising with a given slope is omitted in a reset pulse applied to the scan electrodes in the reset period of at least one of the subfields comprised within one subfield group. For example, as shown in FIG. 20, a reset pulse in the sixth and seventh subfields has a falling ramp waveform Ram-down maintaining a positive voltage of a predetermined amplitude and then falling. The reset pulse of the sixth and seventh subfields does not have a rising ramp when compared with a reset pulse applied to the scan electrodes in the reset period of the other subfields, that is, the first to fifth subfields, maintain a positive voltage in the sixth and seventh subfields in a period a rising ramp is applied in the other subfields, and then has a falling ramp waveform.

It is preferable that the subfield applying a reset pulse without a rising ramp is a high gray level subfield. Accordingly, the amount of an unnecessary discharge not contributing to an image display is further reduced in the reset period of a high gray level subfield generating a relatively stable discharge, unlike the low gray level subfield, thereby further improving the contrast.

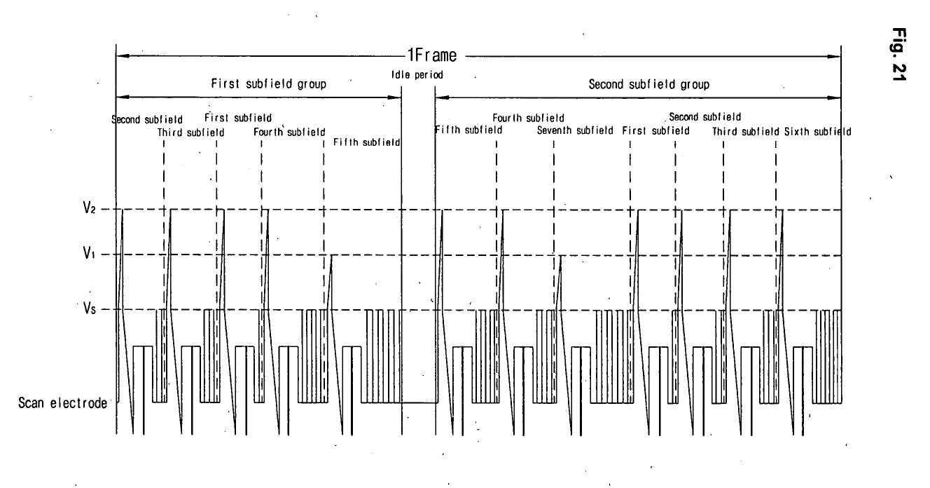

Although one example described above shared where subfields comprised in one subfield group are uniformly arranged in the order of a weight value, that is, a gray level value, it is also may be possible to arrange subfields irregularly in one subfield group. Such an example of a driving method will be shown in FIG. 21.

FIG. 21 explains an arrangement of subfields within one subfield group in the second embodiment of the driving method of the plasma display panel according to the present invention.

As shown in FIG. 21, subfields within one subfield group are not regularly arranged in the order of a weight value, i.e., in the order of a gray level value, but are randomly arranged regardless of a gray level value. Even within the subfield group having such an irregular subfield arrangement, the amplitude of reset pulses applied to the scan electrodes in the reset period in a high level subfield, for example, in the third foremost subfield of the second subfield group, that is, in the seventh subfield, is less than in the other subfields.

When comparing FIG. 21 with FIG. 18a, if the subfield arrangement of FIG. 18a is in the order of the first, second, third, fourth and fifth subfields within the first subfield group, and in the order of the first, second, third, fourth, fifth, sixth and seventh subfield within the second subfield group, the subfield arrangement of FIG. 17 is in the order of the second, third, first, fourth and fifth subfields within the first subfield group and in the order of the fifth, fourth, seventh, first, second, third and sixth subfields within the second subfield group. Although in FIG. 17, the subfields are randomly arranged regardless of a weight value, i.e., a gray level value, within one subfield group, it is also possible to alternately arrange high gray level subfields having a relatively high weight value, i.e., a high gray level value, and low gray level subfields having a relatively low weight value, i.e., a low gray level value within one subfield group. The present invention is not limited by the above-described order of subfield arrangement, even if the present invention has a certain subfield arrangement of a subfield group, it is most important to make the amplitude of reset pulses, applied to the scan electrodes in the reset period of high gray level subfields among the subfields comprise in the subfield group, less than the amplitude of the reset pluses in the other subfields.

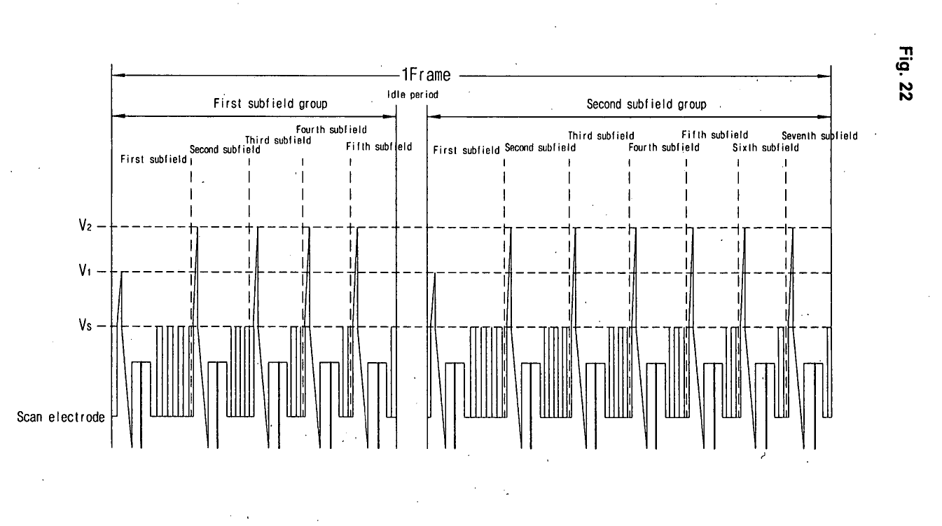

The above description has referred to the arrangement of subfields within one subfield group in increasing order of a weight value, i.e., a gray level value. However it is also possible to arrange subfields within at least one subfield group in decreasing order of a gray level value as shown in FIGS. 14a and 14b. This will be shown in FIG. 22.

FIG. 22 explains another arrangement of subfields within one subfield group in the second embodiment of the driving method of the plasma display panel according to the present invention.

As shown in FIG. 22, one frame is divided into a plurality of subfield groups, and subfields are arranged within at least one subfield group in decreasing order of a weight value, i.e., a gray level value. That is, in FIG. 22, the order of arrangement of subfields within each subfield group is opposite to that of FIG. 18a.

In the method of dividing one frame into a plurality of subfield groups for its driving, even in the event that subfields are arranged within one subfield group in a reverse order of gray level values, the amplitude of reset pulses supplied in the reset period in high gray level subfields having a relatively high weight value is less than the amplitude of the reset pluses in the other subfields.

In the above description, one frame is divided into a plurality of subfield groups, and one idle period is comprised between the plurality of divided subfield groups. However, also in the second embodiment of the driving method of the present invention it is also possible to further comprise an idle period having a predetermined time duration between the subfield groups as well as between frames as shown in FIGS. 16a and 16b.

As shown in FIGS. 17a and 17b, the subfields are arranged within the subfield groups in the order opposite to that of FIGS. 16a and 16b. It also may be possible to comprise respective idle periods, that is, a first idle period and a second idle period, between the subfield groups and between the frames as shown in FIGS. 16a and 16b.

Since one example of including respective idle periods having a predetermined time duration between the respective frames and between the respective subfield groups has been described in detail in the aforementioned driving method of the present invention, a repetitive explanation will be omitted.

In the above description, the amplitude of reset pulses applied to the scan electrodes in the reset period of the subfields comprised within one subfield group is adjusted in low gray level subfields or in high gray level subfields. However, it also may be possible to set reset pulses of the subfields comprised in one subfield group to have at least three different voltage values. Such a driving method is the same as in the following third embodiment of a driving method of a plasma display panel of the present invention.

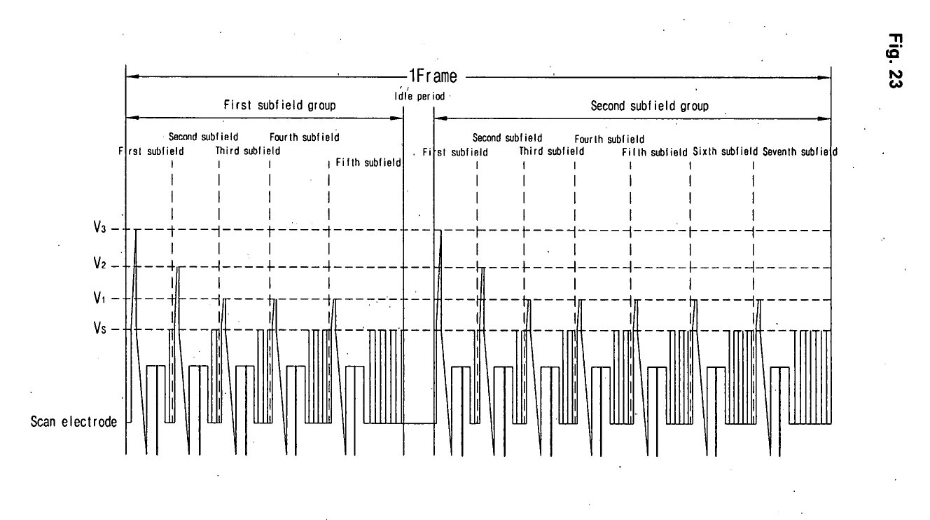

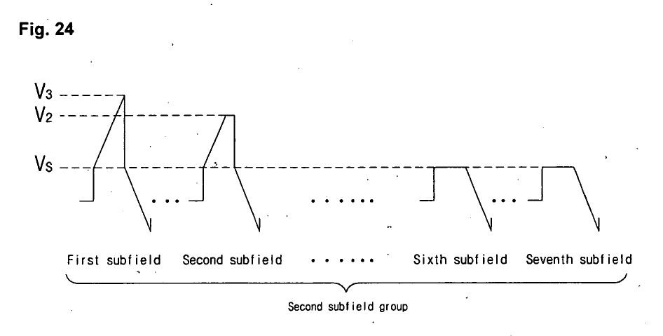

FIG. 23 explains a third embodiment of a driving method of a plasma display panel according to the present invention.

As shown in FIG. 23, in the third embodiment of the driving method of the plasma display panel including scan electrodes, sustain electrodes and address electrodes intersecting the scan electrodes and the sustain electrodes, one frame is divided into a plurality of subfield groups including at least one subfield, and the amplitude of the reset pulses, applied to the scan electrodes in the reset period of one or more subfields in at least one of the plurality of subfield groups, is adjusted according to a gray level value.

For example, as shown in FIG. 23, in the event that one frame is divided into two subfield groups, the amplitude of reset pulses is adjusted according to a weight value, that is, a gray level, of corresponding subfields in each subfield group.

In the second subfield group consisting of a total of seven subfields, if the amplitude of reset pulses applied to the scan electrodes in the reset period of the last subfield, that is, the seventh subfield, implementing the highest gray level in the order of a weight value, i.e., a gray level value, and of the sixth subfield of the next highest gray level and of the fifth, fourth and third subfields is V1, the amplitude of reset pulses applied to the scan electrodes in the reset period of the foremost subfield, that is, the first subfield, implementing the lowest gray level in the order of a weight value, i.e., a gray level value is V3, and the amplitude of reset pulses applied to the scan electrodes in the reset period of the second subfield having an intermediate gray level value between the above two values is V2, the relationship of V1<V2<V3 is established.

As described above, the subfield having an amplitude of reset pulses of V1 is a high gray level subfield. Preferably, the amplitude V1 of the reset pulses applied to the scan electrodes in the reset period of such a high gray level subfield is more than a sustain voltage Vs and less than two times the sustain voltage Vs, i.e., less than 2Vs, that is, Vs≦V1≦2Vs.

The subfield having an amplitude of a voltage of the reset pulses of more than a sustain voltage Vs and less than two times the sustain voltage Vs, i.e., Vs≦V1≦2Vs, that is, a high gray level subfield, can be determined according to a number of sustain pulses supplied in the sustain period of a subfield of one subfield group. For example, it is preferable that a high gray level subfield is a subfield supplying less than ½ of the total number of sustain pulses of the subfields having the largest number of sustain pulses supplied in the sustain period of a subfield of one frame.

It is also possible to set subfields supplying a number of sustain pulses that is less than 20% of the total number of sustain pulses of one frame as high gray level subfields.

The reason why the amplitude of the reset pulses in high gray level subfields of one subfield group is less than the amplitude of the reset pluses in the other subfields, preferably, has a voltage more than the sustain voltage Vs and less than two times the sustain voltage 2Vs is because an address discharge is relatively stable and the number of sustain pulses is relatively large in high gray level subfields to thus stabilize discharges throughout the high gray level subfields. In other words, since a discharge is stabilized throughout the high gray level subfields, even if the amplitude of reset pulses in the reset period is relatively small, wall charges can be distributed uniformly within discharge cells throughout the plasma display panel. As a consequence, by setting the amplitude of a voltage of reset pulses applied to the scan electrodes in the reset period of the high gray level subfields, wall charges are uniformly distributed within discharge cells and the amount of light generated by a dark discharge in the reset period is reduced thereby improving the contrast.

As described above, the subfield having an amplitude of the reset pulses of V3 is a low gray level subfield. Preferably, the amplitude V3 of the reset pulses applied to the scan electrodes in the reset period of a low gray level subfield has a voltage value more than two times the sustain voltage Vs, i.e., a voltage more than 2Vs. The reason why the amplitude of reset pulses in low gray level subfields is more than the amplitude of the reset pluses in the other subfields is as follows. Low gray level subfields implementing low gray levels due to their relatively low weights have a higher probability of creating an unstable address discharge than subfields implementing high gray levels due to their relatively high weights. Therefore, the amplitude of reset pulses is than in the amplitude of the reset pluses the other subfields, to stabilize address discharge and sustain discharge. The reason why the amplitude of reset pulses in low gray level subfields is more than has been described in detail in the first or second embodiment of the driving method of the plasma display panel according to the present invention, thus a repetitive explanation will be omitted.

The subfields in which the amplitude of reset pulses in one subfield group is set as a voltage more than two times a sustain voltage Vs, that is, low gray level subfields, can be determined in terms of the number of sustain pulses. For example, the subfields in which the amplitude of reset pulses have a voltage more than two times the sustain voltage Vs are the subfields supplying a number of sustain pulses that is less than ½ of the total number of sustain pulses of the subfields having the largest number of sustain pulses supplied in the sustain period within one frame or the subfields supplying a number of sustain pulses that is less than 20% of the total number of sustain pulses of one frame.

A more detail description of the method for determining the subfields in which the amplitude of reset pulses is set as a voltage more than two times a sustain voltage Vs has been made in detail in the first or second embodiment of the driving method of the plasma display panel according to the present invention, thus a repetitive explanation will be omitted.

The reset pulse whose amplitude is adjusted according to a gray level value of the subfields has at least three different voltage values within one subfield group. In other words, the voltage values of the reset pulses of the subfields within one subfield group are at least three different values. Also, it is preferable that the lower the weight value, i.e., gray level value of a corresponding subfield within one subfield group, the higher the voltage value. For example, if the amplitude of the reset pulses in the second and third subfield have a different voltage value in decreasing order of a weight value, i.e., gray level value, within one subfield group, the amplitude of reset pulses in the subfield having a lower weight value, i.e., a lower gray level value, among the second and third subfields, that is, the amplitude of the reset pulses in the second subfield is more than the amplitude of the reset pluses of reset pulses in the third subfield.

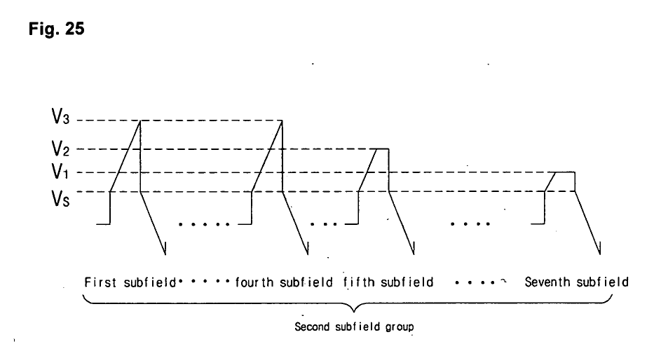

In the above explanation, a rising ramp Ramp-up rising with a given slope is also comprised in every subfield within one subfield group. However it is also possible to apply a reset pulse in a manner that the rising ramp may not be comprised in the reset period of one or more subfields of the subfield groups. Such a driving waveform will be shown in FIG. 24.

FIG. 24 explains another driving waveform according to the third embodiment of the driving method of the plasma display panel according to the present invention.

As shown in FIG. 24, in another driving waveform according to the second embodiment of the driving method of the plasma display panel according to the present invention, a rising ramp Ramp-up rising with a given slope is omitted in a reset pulse applied to the scan electrodes in the reset period of at least one of the subfields comprised within one subfield group. For example, as shown in FIG. 24, a reset pulse in the sixth and seventh subfields has a falling ramp waveform Ram-down maintaining a positive voltage of a predetermined amplitude and then falling with a slope. The reset pulse of the sixth and seventh subfields has no rising ramp when compared with a reset pulse applied to the scan electrodes in the reset period of the other subfields, that is, the first to fifth subfields, maintains a positive voltage in the seventh and eighth subfields in a period a rising ramp is applied in the other subfields, and then has a falling ramp waveform. One or more-of such a subfield may be comprised in one frame.

In the case of determining the subfields within one subfield group having an amplitude of the reset pulses more than the amplitude of the reset pluses the other subfields, for instance, an amplitude of the reset pulses of V3 as shown in FIG. 23, the amplitude of reset pulses in the subfield having more than a predetermined number of sustain pulses with respect to the number of sustain pulses comprised within one subfield group is set as V3. However, the subfields having an amplitude of reset pulses of V3 can be determined with respect to the order of the smallest number of sustain pulses in each frame. Such a method will be described in FIG. 25.

FIG. 25 explains one example of a low gray level subfield setting method in the third embodiment of the driving method of the plasma display panel according to the present invention.

As shown in FIG. 25, a plurality of subfields are set as low gray level subfields in one subfield group. The subfields whose number of sustain pulses is the lowest to fourth lowest are set as low gray level subfields within one subfield group in the order of the smallest number of sustain pulses. For example, as shown in FIG. 25a, the subfields having the lowest gray level value, that is, the first subfield to the next subfields, including the second, third and fourth subfields, are set as low gray level subfields in the order of the lowest weight value, i.e., of the lowest gray level value, and the amplitude of reset pulses is set as V3. Since a detail description of the method of setting low gray level subfields has already been made in FIG. 11, a repetitive explanation will be omitted.

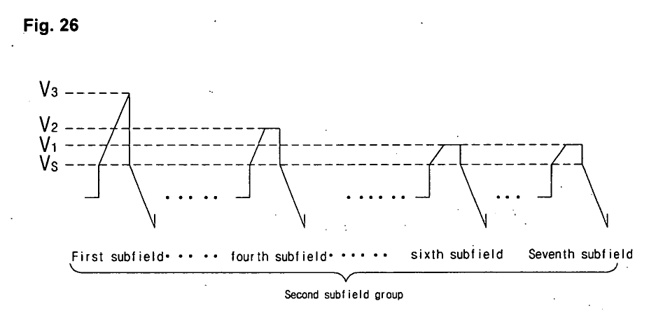

In the case of determining the high gray level subfields, that is, the subfields within one subfield group having an amplitude of the reset pulses less than the amplitude of the reset pluses the other subfields, for instance, an amplitude of the reset pulses of V1 as shown in FIG. 23, the amplitude of the reset pulses in the subfield having more than a predetermined number of sustain pulses with respect to the number of sustain pulses comprised within one frame is set as V1. However, the subfields having an amplitude of the reset pulses of V1 can be determined with respect to the order of the largest number of sustain pulses in each frame. Such a method will be described in FIG. 26.

FIG. 26 explains one example of a high gray level subfield setting method in the third embodiment of the driving method of the plasma display panel according to the present invention.

As shown in FIG. 26, a plurality of subfields are set as high gray level subfields in one subfield group. Although FIG. 26 illustrates two high gray level subfields as being comprised in one subfield group. It is preferable that the subfields whose number of sustain pulses is the largest to fourth largest are set as high gray level subfields within one subfield group in the order of the largest number of sustain pulses. For example, as shown in FIG. 25a, the subfields having the highest gray level value, that is, the seventh subfield to the next subfields, including the sixth, fifth and fourth subfields, are set as high gray level subfields in the order of the highest weight value, i.e., of the highest gray level value, and the amplitude of the reset pulses is set as V1. Since a detailed description of the method of setting high gray level subfields has already been made in FIG. 19, a repetitive explanation will be omitted.

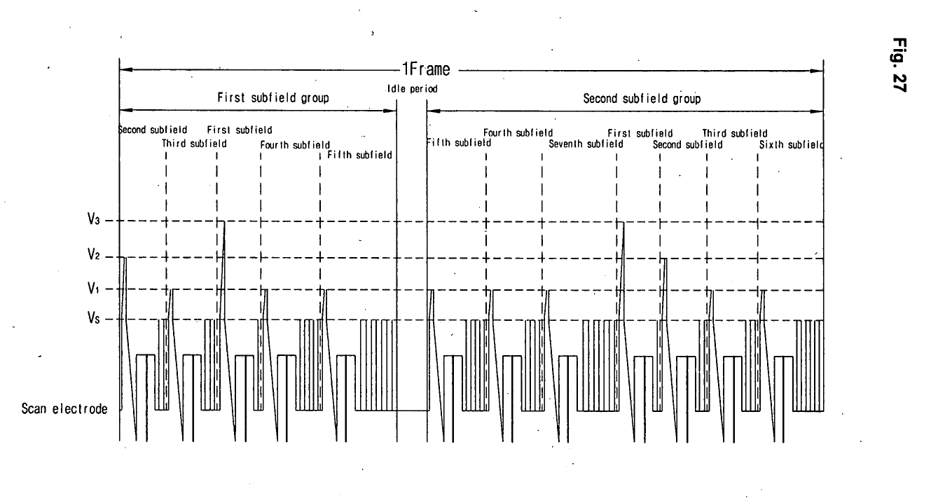

One example in which subfields comprised in one subfield group are regularly arranged in the order of a weight value, i.e., a gray level value, has been explained in the third embodiment of the driving method of the plasma display panel according to the present invention. However, it is also possible to irregularly arrange subfields within one subfield group. Such an example of the driving method will be described in FIG. 27.

FIG. 27 explains an arrangement of subfields within one frame in the third embodiment of the driving method of the plasma display panel according to the present invention.

As shown in FIG. 27, subfields within one subfield group are not regularly arranged in the order of a weight value, i.e., in the order of a gray level value, but are randomly arranged regardless of a gray level value. When comparing FIG. 27 with FIG. 23a, if the subfield arrangement is made in the order of the second, third, first, fourth and fifth subfields within the first subfield group, and in the order of the fifth, fourth, seventh, first, second, third and sixth subfields within the second subfield group.

For example, the second subfield group having such an irregular subfield arrangement, if the amplitude of the reset pulses supplied in the reset period of the fourth foremost subfield, that is, the first subfield, which is a low gray level subfield implementing a low gray level due to its low gray level value, is V3, the amplitude of the reset pulses supplied in the reset period of the third, fourth, fifth, sixth and seventh subfields which are high gray level subfields implementing a high gray level due to their high gray level is V1, and the amplitude of reset pulses supplied in the reset period of the fifth foremost subfield, that is, the second subfield, which is the remaining intermediate gray level subfield excepting the above low gray level subfield and high gray level subfield, is V2, the relation of V1<V2<V3 is established.

Although on example described above shared the case in which the amplitude of reset pulses supplied in the reset period of subfields within one subfield group are set as a total of three different values., it is also possible to set the amplitude of the reset pulses supplied in the reset period of each subfield within one subfield group to be different from each other. For example, if one subfield group consists of seven subfields, the amplitude of the reset pulses of the first subfield is set as V1, the amplitude of reset pulses of the second subfield is set as V2, the amplitude of the reset pulses of the third subfield is set as V3, the amplitude of the reset pulses of the fourth subfield is set as V4, the amplitude of the reset pulses of the fifth subfield is set as V5, the amplitude of reset pulses of the sixth subfield is set as V6, and the amplitude of the reset pulses of the seventh subfield is set as V7. The above V1 to V7 have different values.

As described above, in the third embodiment of the driving method of the plasma display panel according to the present invention, in one subfield group, the amplitude of reset pulses in at least one high gray level subfield is less than in the other subfields, the amplitude of reset pulses in at least one low gray level subfield is more than in the other subfields, and the amplitude of the reset pulses in a subfield implementing an intermediate gray level between the above high gray level subfield and low gray level subfield is more than in the high gray level subfield but less than in the low gray level subfield, whereby a reset discharge is stabilized by a reset pulse having a relatively large amplitude in the low gray level subfield having a relatively high probability of making an address discharge unstable, thereby stabilizing a subsequent address discharge. Also, in the high gray level subfield in which an address discharge is relatively more stable than in the above low gray level subfield, the generation of unnecessary light not contributing to an image display due to a dark discharge is reduced by a reset pulse of a relatively small amplitude, thereby improving the contrast. Furthermore, in the third embodiment of the driving method of the plasma display panel according to the present invention, subfields in a subfield group are not divided into two types of high gray level subfields and low gray level subfields, but they are subject to have reset pulses of at least three different amplitudes within the subfield group, thereby enabling it to apply reset pulses of the optimum amplitude according to a weight value, i.e., gray level value, of each subfield. As a consequence, the driving margin can be further improved, and the degradation of the contrast will be suppressed.

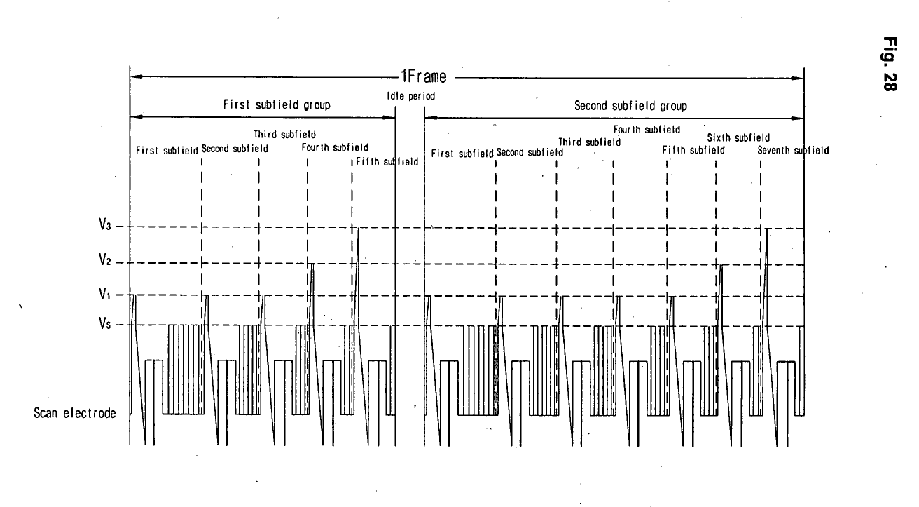

Although the third embodiment of the driving method according to the present invention has been explained with respect to the case in which subfields within one subfield group are arranged in decreasing order of a weight value, i.e., a gray level value, or in random order, it is also possible to arrange the subfields in decreasing order of a gray level value. This will be described in FIG. 28.

FIG. 28 explains another arrangement of subfields within one subfield group in the third embodiment of the driving method of the plasma display panel according to the present invention.

As shown in FIG. 28, one frame is divided into a plurality of subfield groups, and the subfields are arranged within at least one subfield group in decreasing order of a weight value, i.e., a gray level value. That is, in FIG. 28, the order of arrangement of subfields within each subfield group is opposite to that of FIG. 23.

In the method of dividing one frame into a plurality of subfield groups for its driving, even in the event that subfields are arranged within one subfield group in a reverse order of gray level values, the amplitude of the reset pulses supplied in the reset period in high gray level subfields having a relatively high weight value is less than the amplitude of the reset pluses in the other subfields. Moreover, the amplitude of reset pulses in low gray level subfields is more than the amplitude of the reset pluses in the other subfields. Furthermore, in intermediate gray level subfields having a lower gray level than in the high gray level subfields but a higher gray level than in the low gray level subfields, the amplitude of reset pulses supplied in the reset period more than the amplitude of reset pulses in the high gray level subfields but less than the amplitude of reset pulses in the low gray level subfields.

The low gray level subfield setting method or high gray level subfield setting method in the third embodiment of the driving method of the plasma display panel according to the present invention has been descried in detail, thus a repetitive explanation will be omitted.

In the above description of the third embodiment of the driving method according to the present invention, one frame is divided into a plurality of subfield groups, and one idle period is comprised between the plurality of divided subfield groups. However also in the third embodiment of the driving method of the present invention it is also possible to further comprise an idle period having a predetermined time duration between the subfield groups as well as between frames as shown in FIGS. 16a and 16b.

As shown in FIGS. 17a and 17b, the subfields are arranged within the subfield groups in the order opposite to that of FIGS. 16a and 16b, while it is also possible to comprise respective idle periods, that is, a first idle period and a second idle period, between the subfield groups and between the frames as shown in FIGS. 16a and 16b.

Since one example of including respective idle periods having a predetermined time duration between the respective frames and between the respective subfield groups has been described in detail in the aforementioned driving method of the present invention, a repetitive explanation will be omitted.

In the first, second and third embodiments of the driving method of the plasma display panel according to the present invention, the amplitude of the reset pulses is adjusted according to a gray level value of a corresponding subfield. However it is also possible to adjust the number of reset pulses according to a gray level value of a corresponding subfield. Such a driving method will be described as in the following fourth embodiment.

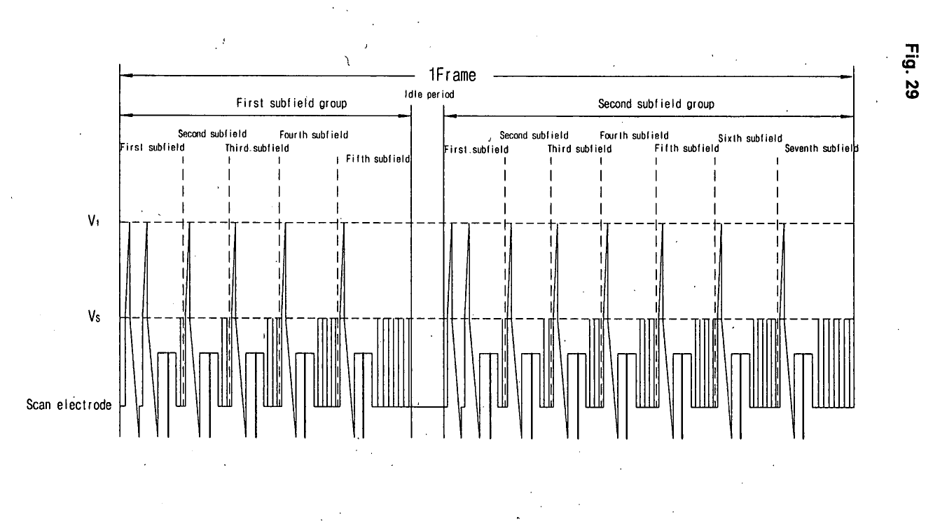

FIG. 29 explains a fourth embodiment of a driving method of a plasma display panel according to the present invention.

As shown in FIG. 29, in the fourth embodiment of the driving method of the plasma display panel including scan electrodes, sustain electrodes and address electrodes intersecting the scan electrodes and the sustain electrodes, one frame is divided into a plurality of subfield groups including at least one subfield, and the number of reset pulses, applied to the scan electrodes in the reset period of low gray level subfields in at least one of the plurality of subfield groups, is more than in the other subfields.

For example, as shown in FIG. 29a, where one frame is divided into two subfield groups, that is, a first subfield group and a second subfield group, the number of reset pulses, applied to the scan electrodes in the reset period of the foremost subfields implementing the lowest gray level due to its lowest weight value, that is, of the first subfield in the first subfield group and of the first subfield in the second subfield group, is more than the number of reset pulses in the other subfields, that is, in the second, third, fourth and fifth subfields of the first subfield group and in the second, third, fourth, fifth, sixth and seventh subfields of the second subfield group. In FIG. 29, the number of reset pulses of one subfield of the subfield groups, i.e., both first subfield group and second subfield group, of one frame is more than the number of reset pluses in the other subfields. However it is also possible to adjust the number of reset pulses only in some selected subfield group among the plurality of subfield groups, for example, in either one of the first subfield group and the second subfield group of FIG. 29.

Preferably, the number of reset pulses applied to the scan electrodes in the reset period of low gray level subfields is two or more.

The reason why the number of reset pulses in low gray level subfields of one subfield group is more than the number of reset pluses in the other subfields is described as follows.

Low gray level subfields implementing low gray levels due to their relatively low weights have a higher probability of making an address discharge unstable than subfields implementing high gray levels due to their relatively high weights. As a consequence, if the amplitude of reset pulses applied to the scan electrodes in the reset period is excessively small, wall charges are not uniformly distributed within discharge cells, and thus a subsequent address discharge will be unstable, thereby causing address jitter to deteriorate and causing subsequent unstables sustain discharge

The number of low gray level subfields causing an unstable discharge increases in the PAL method in which one frame is divided into a plurality of subfield groups for its driving. For example, where subfields with a weight of less than 10, that is, a gray level value of less than 10, are set as low gray level subfields, in the prior art driving method of FIG. 2, the low gray level subfields comprise a first subfield with a gray level of 1, a second subfield of a gray level of 2, a third subfield of a gray level of 4, and a fourth subfield of a gray level of 8, that is, a total of four low gray level subfields. In the PAL driving method of FIG. 9a, the low gray level subfields with a weight of less than 10, that is, a gray level of less than 10, comprise a first subfield of a gray level of 1 and a second subfield of a gray level of 8 in the first subfield group and a first subfield of a gray level of 2, a second subfield of a gray level of 4, a third subfield of a gray level of 8 and a fourth subfield of a gray level of 8. In other words, the number of low gray level subfields is more in the PAL method.

Therefore, in the PAL method, the number of the reset pulses applied in the reset period of low gray level subfields is more than the number of reset pluses in the other subfields, thereby suppressing flicker and stabilizing an address discharge in the low gray level subfields. Once the address discharge is stabilized, the deterioration of the driving margin of the entire plasma display apparatus is suppressed.

The above-described low gray level subfields can be determined according to the number of sustain pulses supplied in the sustain period. For example, it is preferable that these low gray level subfields are the subfields supplying a number of sustain pulses that is less than ½ of the total number of sustain pulses of the subfields having the largest number of sustain pulses supplied in the sustain period within one frame.

However it is also possible to set the subfields supplying a number of sustain pulses that is less than 20% of the total number of sustain pulses of one frame as low gray level subfields. Since such a low gray level subfield setting method has been described in detail in the first embodiment of the present invention, a repetitive explanation will be omitted.

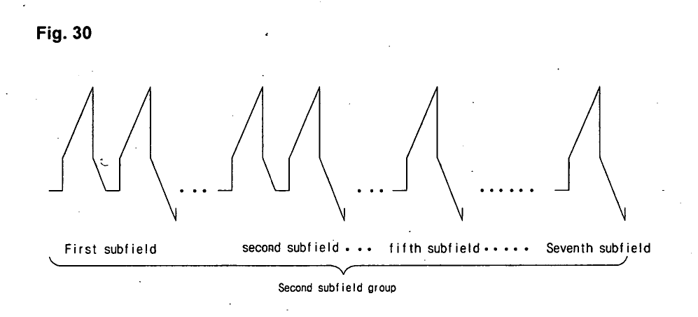

It is also possible to set low gray level subfields in the order of the smallest number of sustain pulses within one subfield group. One example of setting low gray level subfields will be shown in FIG. 30.

FIG. 30 explains one example of a low gray level subfield setting method in the fourth embodiment of the driving method of the plasma display panel according to the present invention.

As shown in FIG. 30, a plurality of subfields are set as low gray level subfields in one subfield group. Although FIG. 30 illustrates two low gray level subfields as being comprised in one subfield group, it is preferable that the subfields whose number of sustain pulses is the lowest to fourth lowest are set as low gray level subfields in the order of the lowest number of sustain pulses. For example, if a total of 7 subfields comprises the second subfield group as in the second subfield group of FIG. 29a, the first subfield implementing the lowest gray level due to its lowest number of sustain pulses, that is, the lowest weight value, and the next subfields including the second, third and fourth subfields are set as low gray level.

As described above, the number of reset pulses in the low gray level subfields is more than the number of reset pluses in the other subfields. That is, as shown in FIG. 30, the number of reset pulses applied to the scan electrodes in the reset period of the first and second subfields set as the low gray level subfields is more than in the other subfields, for example, is set as 2, and the number of reset pulses applied to the scan electrodes in the reset period of the other subfields is set as 1, which is less than in the first and second subfields.

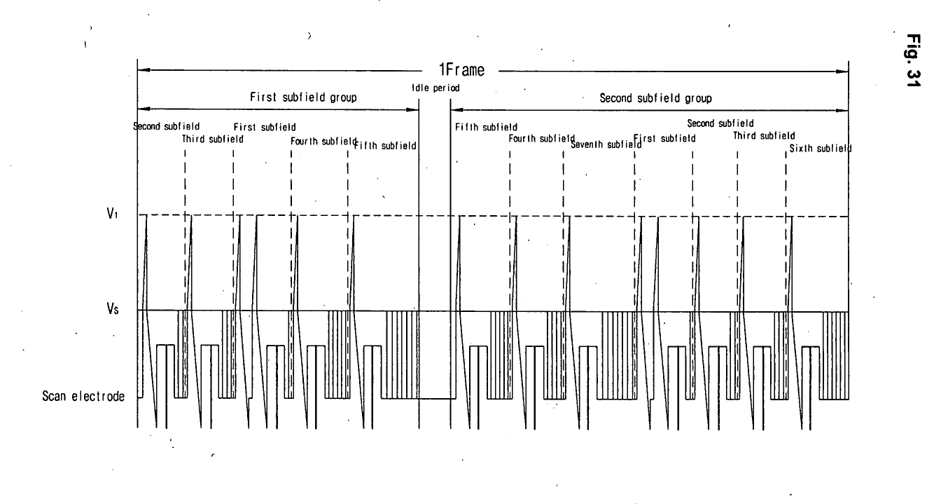

One example in which subfields comprised in one subfield group are regularly arranged in the order of a weight value, i.e., a gray level value, has been explained However, it is also possible to irregularly arrange subfields within one subfield group. Such an example of the driving method will be described in FIG. 31.

FIG. 31 explains an arrangement of subfields within one frame in the fourth embodiment of the driving method of the plasma display panel according to the present invention.

As shown in FIG. 31, the subfields within one subfield group are not regularly arranged in the order of a weight value, i.e., in the order of a gray level value, but are randomly arranged regardless of a gray level value. Even within the subfield group having such an irregular subfield arrangement, the number of reset pulses applied to the scan electrodes in the reset period of the third foremost subfield of the first subfield group, which is a low gray level subfield, that is, in the first subfield is more than the number of reset pluses in the other subfields, for example, 2, and the number of reset pulses applied to the scan electrodes in the reset period of the fourth foremost subfield of the second subfield group, that is, of the first subfield is more than the number of reset pluses in the other subfields, that is, 2.

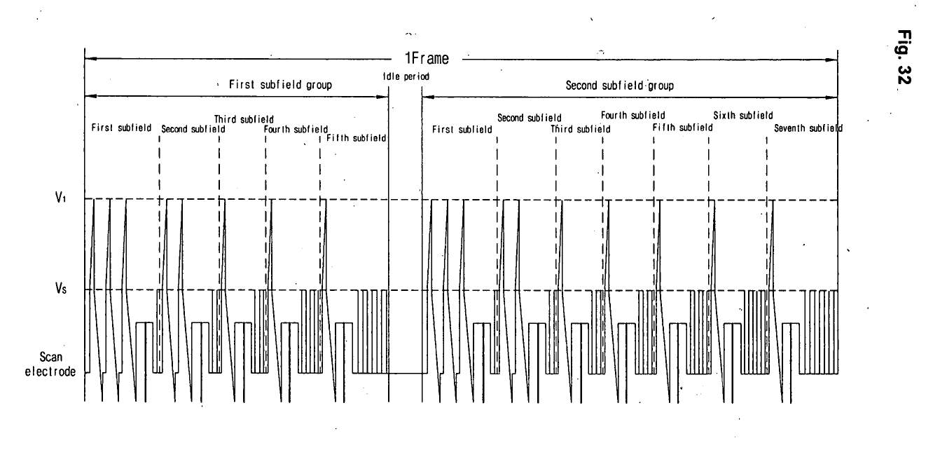

The fourth embodiment of the driving method according to the present invention has been explained with respect to the case in which the number of reset pulses in low gray level subfields within one subfield group is the same in every low gray level subfield, for example, 2, as shown in FIG. 30, However it is also possible to set the number of reset pulses in low gray level subfields in one subfield group to be different from each other. This will be described in FIG. 32.

FIG. 32 explains the number of reset pulses in the fourth embodiment of the driving method of the plasma display panel according to the present invention.

As shown in FIG. 32, unlike FIG. 29, a plurality of low gray level subfields is comprised in one subfield group, and the number of reset pulses of one of the plurality of low gray level subfields is different from the number of reset pluses in the other low gray level subfields.

For example, when one frame is divided into two subfield groups as shown in FIG. 32, the number of reset pulses is adjusted according to a weight value, i.e., gray level, of a corresponding subfield within each subfield group.

As shown in FIG. 32, in the second subfield group consisting of a total of seven subfields, the number of reset pulses applied to the scan electrodes in the reset period of the foremost subfield, that is, the first subfield, implementing the lowest gray level in the order of the lowest weight value, i.e., gray level value, and the number of reset pulses applied to the scan electrodes in the reset period of the second subfield of the next highest gray level are more than the number of reset pluses in the other subfields. The number of reset pulses of the first subfield and the number of reset pulses of the second subfield are different from each other. For example, the number of reset pulses of the first subfield is three, and the number of reset pulses of the second subfield is two. In other words, in the event that low gray level subfields including different numbers of reset pulses are comprised in one subfield group, the lower the gray level value in the subfield group is, the larger number of reset pulses in these low gray level subfields.

By setting the number of reset pulses in low gray level subfields among the subfields of one subfield group to be more than in the other subfields, preferably, two or more, the amount of wall charges within discharge cells are uniformly distributed in the low gray level subfields in which discharges are relatively unstable, thereby stabilizing such discharges. Particularly, the number of reset pulses in the low gray level subfields having a lower gray level value among the above low gray level subfields is more than the number of reset pluses in the other low gray level subfields, thereby stabilizing discharge upon driving the plasma display panel.

In the fourth embodiment of the driving method of the plasma display panel according to the present invention, as shown in FIGS. 14a and 14b, the arrangement of subfields within one subfield group can in decreasing order of gray level values.

As shown in FIG. 13, the arrangement of subfields can be made randomly regardless of a gray level value.

In the fourth embodiment of the driving method of the plasma display panel as in the above first, second and third embodiments, as shown in FIGS. 16a and 16b, it is possible to further comprise an idle period having predetermined time duration between subfield groups as well as between frames.

As shown in FIGS. 17a and 17b, the subfields are arranged within the subfield groups in the order opposite to that of FIGS. 16a and 16b, while it is also possible to comprise respective idle periods, that is, a first idle period and a second idle period, between the subfield groups and between the frames as shown in FIGS. 16a and 16b.

Since one example of including respective idle periods having a predetermined time duration between the respective frames and between the respective subfield groups has been described in detail in the aforementioned driving method of the present invention, a repetitive explanation will be omitted.

The invention being thus described, may be varied in many ways, Such variations are not to be regarded as a departure from the spirit and scope of the invention, and all such modifications as would be obvious to one skilled in the art area intended to be comprised within the scope of the following claims.

What is claimed is:

1. A plasma display apparatus displaying an image in a frame having a plurality of subfield groups, the plasma display apparatus comprising:
a plasma display panel comprising a scan electrode and a sustain electrode; and
a reset pulse controller for controlling a amplitude of reset pulse applied to the scan electrode in the reset period of at least one subfield according to a gray level.

2. The plasma display apparatus of claim 1, wherein the reset pulse controller allows the amplitude of reset pulses to have three or more different voltage values within at least one subfield group.

3. The plasma display apparatus of claim 2, wherein the reset pulse controller makes the amplitude of reset pulses higher as gray level values of corresponding subfields become lower.

4. The plasma display apparatus of any one of claims 1 to 3, wherein the reset pulse controller sets the amplitude of at least one of the reset pulses within at least one subfield group have a voltage to be more than two times the sustain voltage Vs.

5. The plasma display apparatus of claim 4, wherein the subfields in which the amplitude of reset pulse has a voltage more than two times the sustain voltage Vs are the subfields whose number of sustain pulses are the lowest to fourth lowest supplied in a sustain period within one subfield group in the order of the lowest number of sustain pulses.

6. The plasma display apparatus of claim 4, wherein the subfields in which the amplitude of reset pulses have a voltage more than two times the sustain voltage Vs are the subfields supplying sustain pulses less than ½ of the total number of sustain pulses of the subfields having the largest number of sustain pulses supplied in the sustain period within one frame.

7. The plasma display apparatus of claim 4, wherein the subfields in which the amplitude of reset pulses have a voltage more than two times the sustain voltage Vs are the subfields supplying a number of sustain pulses that is less than 20% of the total number of sustain pulses of one frame.

8. The plasma display apparatus of any one of claims 1 to 3, wherein the reset pulse controller sets the amplitude of at least one of the reset pulses within at least one subfield group to a voltage ranging from one to two times the sustain voltage Vs.

9. The plasma display apparatus of claim 8, wherein the subfields in which the amplitude of the reset pulse has a voltage ranging from 1 to 2 times the sustain voltage Vs are the subfields whose number of sustain pulses is the largest to fourth largest supplied in a sustain period within one subfield group in decreasing number of the number of sustain pulses.

10. The plasma display apparatus of claim 8, wherein the subfields in which the amplitude of reset pulses have a voltage ranging from 1 to 2 times the sustain voltage Vs are the subfields supplying a number of sustain pulses that is more than ½ of the total number of sustain pulses of the subfields having the largest number of sustain pulses supplied in the sustain period within one frame.

11. The plasma display apparatus of claim 8, wherein the subfields in which the amplitude of reset pulses have a voltage ranging from 1 to 2 times the sustain voltage Vs are the subfields supplying a number of sustain pulses that is more than 20% of the total number of sustain pulses of one frame.

12. The plasma display apparatus of any one of claims 1 to 3, wherein the reset pulse controller allows at least one of the reset pulses within at least one subfield group to maintain a positive voltage of a predetermined amplitude and then fall.

13. The plasma display apparatus of claim 12, wherein the positive voltage of the predetermined amplitude is a sustain voltage Vs.

14. The plasma display apparatus of claim 1, wherein the subfields within at least one subfield group are arranged irregularly in the order of gray level values.

15. A driving apparatus of a plasma display panel displaying an image in a frame having a plurality of subfield groups, the driving apparatus of a plasma display panel comprising:
a scan driver for applying reset pluse to a scan electrode; and
a reset pulse controller for controlling a amplitude of the reset pulse according to a gray level in the reset period of at least one subfield.

16. A plasma display panel displaying an image in a frame having a plurality of subfield groups, the plasma display panel comprising:
a scan electrode and a sustain electrode,
wherein a amplitude of reset pulse applied to the scan electrode in the reset period of at least one subfield is adjusted according to a gray level.

17. A method of driving a plasma display apparatus displaying an image in a frame having a plurality of subfield groups, the method comprising:
adjusting a amplitude of reset pulse applied to scan electrode in the reset period of at least one subfield according to a gray level.

18. A plasma display apparatus displaying an image in a frame having a plurality of subfield groups, the plasma display apparatus comprising:
a plasma display panel comprising a scan electrode and a sustain electrode; and
a reset pulse controller for setting a amplitude of reset pulse applied to the scan electrode in reset period of low gray level subfields to be more than a amplitude of reset pulse in the other subfields.

19. The plasma display apparatus of claim 18, wherein the reset pulse controller sets the amplitude of reset pulses applied to the scan electrodes in the reset period of the low gray level subfields within at least one subfield group to a voltage more than two times the sustain voltage Vs.

20. The plasma display apparatus of claim 18 or 19, wherein the low gray level subfields are the subfields whose number of sustain pulses are the lowest to fourth lowest supplied in a sustain period within one subfield group in the order of the lowest number of sustain pulses.

21. The plasma display apparatus of claim 18 or 19, wherein the low gray level subfields are the subfields supplying a number of sustain pulses that is less than ½ of the total number of sustain pulses of the subfields having the largest number of sustain pulses supplied in the sustain period within one frame.

22. The plasma display apparatus of claim 18 or 19, wherein the low gray level subfields are the subfields supplying a number of sustain pulses that is less than 20% of the total number of sustain pulses of one frame.

23. The plasma display apparatus of claim 18, wherein the subfields within at least one subfield group are arranged irregularly in the order of gray level values.

24. The plasma display apparatus of claim 18, wherein the reset pulse controller allows at least one of the reset pulses within at least one subfield group to maintain a positive voltage of a predetermined amplitude and then fall.

25. The plasma display apparatus of claim 24, wherein the positive voltage of the predetermined amplitude is a sustain voltage Vs.

26. A driving apparatus of a plasma display panel displaying an image in a frame having a plurality of subfield groups, the driving apparatus of a plasma display panel comprising:
a scan driver for applying reset plus to a scan electrode; and
a reset pulse controller for setting a amplitude of reset pulse applied to the scan electrode in reset period of low gray level subfields to be more than a amplitude of reset pulse in the other subfields.

27. A plasma display panel displaying an image in a frame having a plurality of subfield groups, the plasma display panel comprising:
a scan electrode and a sustain electrode,
wherein a amplitude of reset pulse applied to the scan electrode in reset period of low gray level subfields is more than a amplitude of reset pulse in the other subfields.

28. A method of driving a plasma display apparatus displaying an image in a frame having a plurality of subfield groups, the method comprising:
setting a amplitude of reset pulse applied to the scan electrode in reset period of low gray level subfields to be more than a amplitude of reset pulse in the other subfields.

29. A plasma display apparatus displaying an image in a frame having a plurality of subfield groups, the plasma display apparatus comprising:
a plasma display panel comprising a scan electrode and a sustain electrode; and
a reset pulse controller for setting a amplitude of reset pulses applied to the scan electrode in the reset period of high gray level subfields to be less than a amplitude of reset pulse in the other subfields.

30. The plasma display apparatus of claim 29, wherein the reset pulse controller sets the amplitude of reset pulses applied to the scan electrodes in the reset period of the high gray level subfields within at least one subfield group to a voltage more than a sustain voltage Vs and less than two times the sustain voltage Vs.

31. The plasma display apparatus of claim 29, wherein the reset pulse controller allows at least one of the reset pulses within at least one subfield group to maintain a positive voltage of a predetermined amplitude and then fall.

32. The plasma display apparatus of claim 31, wherein the subfields in which reset pulses applied to the scan electrodes in the reset period maintain a positive voltage of a predetermined amplitude and then fall are high gray level subfields.

33. The plasma display apparatus of claim 31 or 32, wherein the positive voltage of the predetermined amplitude is a sustain voltage Vs.

34. The plasma display apparatus of any one of claims 29, 30 or 32, wherein the high gray level subfields are the subfields whose number of sustain pulses is the largest to fourth largest supplied in a sustain period within one subfield group in decreasing order of the number of sustain pulses.

35. The plasma display apparatus of any one of claims 29, 30 or 32, wherein the high gray level subfields are the subfields supplying a number of sustain pulses that is more than ½ of the total number of sustain pulses of the subfields having the largest number of sustain pulses supplied in the sustain period within one frame.

36. The plasma display apparatus of any one of claims 29, 30 or 32, wherein the high gray level subfields are the subfields supplying a number of sustain pulses that is more than 20% of the total number of sustain pulses of one frame.

37. The plasma display apparatus of any one of claims 29 to 31, wherein the subfields within at least one subfield group are arranged irregularly in the order of gray level values.

38. A driving apparatus of a plasma display panel displaying an image in a frame having a plurality of subfield groups, the driving apparatus of a plasma display panel comprising:
a scan driver for applying reset pluse to a scan electrode; and
a reset pulse controller for controlling a amplitude of the reset pulse according to a gray level in the reset period of at least one subfield.
a reset pulse controller for setting a amplitude of reset pulses in the reset period of high gray level subfields to be less than a amplitude of reset pulse in the other subfields.

39. A plasma display panel displaying an image in a frame having a plurality of subfield groups, the plasma display panel comprising:
a scan electrode and a sustain electrode,
wherein a amplitude of reset pulses applied to the scan electrode in the reset period of high gray level subfields is less than a amplitude of reset pulse in the other subfields.

40. A method of driving a plasma display apparatus displaying an image in a frame having a plurality of subfield groups, the method comprising:
setting a amplitude of reset pulses in the reset period of high gray level subfields to be less than a amplitude of reset pulse in the other subfields.

41. A plasma display apparatus displaying an image in a frame having a plurality of subfield groups, the plasma display apparatus comprising:
a plasma display panel comprising a scan electrode and a sustain electrode; and
a reset pulse controller for setting the number of reset pulses applied to the scan electrode in the reset period of low gray level subfields to be more than the number of reset pulses in the other subfields.

42. The plasma display apparatus of claim 41, wherein the reset pulse controller allows one subfield group to comprise two or more low gray level subfields and sets the number of reset pulses applied to the scan electrodes in the reset period of the low gray level subfields in the same subfield group to have the same number of reset pulse in each low gray level subfield.

43. The plasma display apparatus of claim 41, wherein the reset pulse controller allows one subfield group to include two or more low gray level subfields and sets the number of reset pulses applied to the scan electrodes in the reset period of one of the low gray level subfields included in the same subfield group to be different from the number of reset pulse in the other low gray level subfields.

44. The plasma display apparatus of claim 43, wherein the lower the gray level value is, the larger number of reset pulses the low gray level subfields having different numbers of reset pulses in one subfield group include.

45. The plasma display apparatus of any one of claims 41 to 44, wherein the low gray level subfields are the subfields whose number of sustain pulses is the lowest to fourth lowest supplied in a sustain period within one subfield group in the order of the lowest number of sustain pulses.

46. The plasma display apparatus of any one of claims 41 to 44, wherein the low gray level subfields are the subfields supplying a number of sustain pulses that is less than ½ of the total number of sustain pulses of the subfields having the largest number of sustain pulses supplied in the sustain period within one frame.

47. The plasma display apparatus of any one of claims 41 to 44, wherein the low gray level subfields are the subfields supplying a number of sustain pulses that is less than 20% of the total number of sustain pulses of one frame.

48. The plasma display apparatus of claim 41, wherein the subfields within at least one subfield group are arranged irregularly in the order of gray level values.

49. A driving apparatus of a plasma display panel displaying an image in a frame having a plurality of subfield groups, the driving apparatus of a plasma display panel comprising:
a scan driver for applying reset pluse to a scan electrode; and
a reset pulse controller for setting the number of reset pulses in the reset period of low gray level subfields to be more than the number of reset pulses in the other subfields.

50. A plasma display panel displaying an image in a frame having a plurality of subfield groups, the plasma display panel comprising:
a scan electrode and a sustain electrode,
wherein the number of reset pulses applied to the scan electrode in the reset period of low gray level subfields is more than the number of reset pulses in the other subfields.

51. A method of driving a plasma display apparatus displaying an image in a frame having a plurality of subfield groups, the method comprising:
setting the number of reset pulses in the reset period of low gray level subfields to be more than the number of reset pulses in the other subfields.

52. The plasma display apparatus of any one of claims 1, 18, 29 or 41, wherein an idle period having a predetermined time duration is further comprised between the frames and the subfield groups of the frames are consecutive within the same frame.

53. The plasma display apparatus of any one of claims 1, 18, 29 or 41, wherein a first idle period having a predetermined time duration is comprised between the frames, and a second idle period having a predetermined time duration is further comprised between the subfield groups within the same frame.

54. The plasma display apparatus of claim 53, wherein the time duration of the first idle period and of the second idle period is the same.

55. The plasma display apparatus of any one of claims 1, 18, 29, 41, 52 or 53, wherein each of the plurality of subfield groups comprises a plurality of subfields, and the plurality of subfield groups are arranged in increasing order of gray level values.

56. The plasma display apparatus of any one of claims 1, 18, 29, 41, 52 or 53, wherein each of the plurality of subfield groups comprises a plurality of subfields, and the plurality of subfield groups are arranged in decreasing order of gray level values.

57. The plasma display apparatus of any one of claims 1, 18, 29, 41, 52 or 53, wherein each frame is divided into two subfield groups, each of the two subfield groups comprises a plurality of subfields, and the two subfield groups are arranged in the order of the amplitude of different gray level values of the subfields within each subfield group.

58. The plasma display apparatus of claim 57, wherein the subfields of one of the two subfield groups are arranged within the group in increasing order of the amplitude of gray levels.

59. The plasma display apparatus of claim 57, wherein the subfields of one of the two subfield groups are arranged within the group in decreasing order of the amplitude of gray levels.

60. The plasma display apparatus of claim 57, wherein the subfields of one of the two subfield groups are arranged within the group in decreasing order of the amplitude of gray levels, and the subfields of one of the two subfield groups are arranged within the group in increasing order of the amplitude of gray levels.
